(19) United States
(12) Patent Application Publication
(10) Pub. No.: US 2008/0160288 A1
(43) Pub. Date: Jul. 3, 2008

(54) Method for Impregnating Lignocellulosic Materials with Effect Agents

(75) Inventors: Arend Jouke Kingma, Ludwigshafen (DE); Hans-Ulrich Reisacher, Maxdorf (DE); Uwe Mauthe, Mannheim (DE); Holger Militz, Bovenden (DE); Andreas Krause, Gottingen (DE); Carsten Mai, Gottingen (DE)

Correspondence Address: OBLON, SPIVAK, MCCLELLAND MAIER & NEUSTADT, P.C., 1940 DUKE STREET, ALEXANDRIA, VA, 22314, US

(73) Assignee: BASF Aktiengesellschaft, Ludwigshafen (DE)

(21) Appl. No.: 11/913,080

(22) PCT Filed: Apr. 28, 2006
(86) PCT No.: PCT/EP06/04019

§ 371 Date: Oct. 30, 2007

(30) Foreign Application Priority Data
May 2, 2005 (DE) 10 2005 020 386.8

(51) Int. Cl. B32B 5/16; B05D 3/02; C08G 67/00

(52) U.S. Cl. 428/326; 427/384; 427/389.9; 524/612; 106/287.23

(57) ABSTRACT

The invention relates to a method for impregnating lignocellulosic materials, in particular, wood, wood materials or materials for manufacturing wood materials, with effect agents. The invention also relates to novel compositions, containing effect agents. Said method comprises the steps of a) impregnating the lignocellulosic material with a fluid formulation, which contains at least one effect agent in a dissolved or dispersed form, b) impregnating said material, during or after step a), with a hardenable aqueous composition, which contains at least one cross-linkable compound, selected from &agr;) low-molecular weight compounds V, having at least two N-bonded groups of formula CH₂OH, wherein R=hydrogen or C₁-C₄ alkyl, and/or one 1,2-bishydroxyethan-1,2-diyl group, bridging two nitrogen atoms, &bgr;) precondensates of the compound V and &gammad;) reaction products or mixtures of the compound V with at least one alcohol, selected from C₁-C₆ alkanols, C₂-C₆ polyols and oligoalkylene glycols, and c) treating the material obtained in step b) at an elevated temperature.

The present invention relates to a process for the impregnation of lignocellulose materials, in particular of wood or woodbase materials or of materials for the preparation of woodbase materials, with effect substances. The invention also relates to new compositions comprising effect substances.

The impregnation of wood with effect substances, such as colorants, but also with substances which are active against wood-discoloring or wood-destroying microorganisms has been well known for a long time (see, e.g., E.-H. Pommer, “Wood—Wood Preservation”, in particular chapter 2, in Ullmann's Encyclopedia of Industrial Chemistry, 5th ed. on CD-ROM, Wiley-VCH, Weinheim, 1997).

DE 3621856 discloses a process for the dyeing of wood in which aqueous coloring preparations are introduced, by application of pressure, into the wood via the faces of a body made of wood. The transportation of the colorant occurs specifically via the lumina of vascular bundle cells of the wood, by which an artificial grain is produced in the wood. Complete impregnation is not achieved by this means.

DE 4316234 discloses the penetration dyeing of wood, in which wood is first moistened with water and then impregnated with an aqueous coloring solution on application of pressure with heating, and subsequently several rinsing operations with decreasing temperature are carried out.

Water-soluble dyes have, however, the disadvantage that they are leached out by the action of moisture, e.g. under the influence of the weather. In principle, the use of pigments should bring about a solution since these are insoluble and accordingly are leached out less readily.

The Applicant Company's own investigations have now shown that effect substances which are insoluble in water per se, such as pigments, are also leached out under the action of water, possibly because of the surface-active substances present in the impregnating preparation, which remain in the wood under the preparation conditions. This leads not only to a loss of the effect substance and therefore to a decline in the desired property, or, in the case of colorants, to a less attractive appearance, but also to an adverse effect on the environment.

It has now been found, surprisingly, that the leaching out of effect substances can be reduced or even avoided if the lignocellulose material impregnated with an effect substance or the lignocellulose material during the impregnation with the effect substance is impregnated with a curable aqueous composition defined below and the lignocellulose material is subsequently treated at elevated temperature, in order to bring about curing.

The present invention accordingly relates to a process for the impregnation of lignocellulose materials with effect substances comprising the following steps:

a) impregnating the lignocellulose material with a liquid preparation comprising at least one effect substance in dissolved or dispersed form, and

b) during or subsequent to step a), impregnating with a curable aqueous composition comprising at least one crosslinkable compound chosen from
α) low molecular weight compounds V exhibiting at least two N-bonded groups of the formula CH₂OR, in which R is hydrogen or C₁-C₄-alkyl, and/or a 1,2-bishydroxyethane-1,2-diyl group bridging two nitrogen atoms,
β) precondensates of the compound V and
γ) reaction products or mixtures of the compound V with at least one alcohol chosen from C₁-C₆-alkanols, C₂-C₆-polyols and oligoalkylene glycols and

c) treating at elevated temperature the material obtained in step b).

There are a number of advantages associated with the process according to the invention. It makes possible uniform impregnation of lignocellulose materials with effect substances and also, with large-scale materials, uniform distribution of the effect substance in the lignocellulose material. Unlike the lignocellulose materials treated with effect substances known in the state of the art, bleeding of the effect substance under the action of organic solvents and/or moisture occurs to a very much lesser extent or not at all. The present invention consequently also relates to the lignocellulose materials obtainable by the process according to the invention.

The process according to the invention is suitable, in contrast to many processes of the state of the art, for the impregnation of any cellulose material with effect substances, the lignocellulose material being able to exhibit any sizes. The process according to the invention is suitable in particular for the impregnation of wood. The process according to the invention makes possible both the impregnation of finely divided materials, such as fibers, shavings, strands, chips, parings and the like, or flat thin materials with thicknesses ≦5 mm, in particular ≦1 mm, such as veneers, as well as, in particular, the impregnation of large-scale parts with minimum sizes of greater than 1 mm, in particular >5 mm, especially ≧10 mm. With the process according to the invention, also with these materials, also with large sizes, uniform impregnation with the effect substance is achieved over the entire cross section of the material.

The process according to the invention is suitable in particular for the impregnation of wood or woodbase materials, especially for the impregnation of solid wood. All wood types are suitable in principle, in particular those which can absorb at least 30%, in particular at least 50%, of their dry weight of water and particularly preferably those which are categorized in the impregnability categories 1 and 2 according to DIN-EN 350-2. These include, for example, wood from conifers, such as pine (Pinus spp.), spruce, Douglas fir, larch, stone pine, fir (Abies species), grand fir, cedar or Swiss pine, and wood from deciduous trees, e.g. maple, hard maple, acacia, ayous, birch, pear, beech, oak, alder, aspen, ash, wild service, hazel, hornbeam, cherry, chestnut, lime, American walnut, poplar, olive, robinia, elm, walnut, gum, zebrano, willow, Turkey oak and the like. Wood which is already impregnated with a curable compound and which has been cured is also suitable. The advantages according to the invention come in useful in particular with the following woods: beech, spruce, pine, poplar, ash and maple. A preferred embodiment of the invention according relates to the impregnation of wood or woodbase materials with effect substances, the wood constituent being chosen from the abovementioned wood types.

The process according to the invention is also suitable for the impregnation of other lignocellulose materials other than wood, e.g. of natural fibrous materials, such as bamboo, bagasse, cotton stems, jute, sisal, straw, flax, coconut fibers, banana fibers, reeds, e.g. Chinese silvergrass, ramie, hemp, manila hemp, esparto (alfa grass), rice husks and cork.

The term “effect substance” comprises, here and subsequently, both organic and inorganic materials which bestow, on the lignocellulose material, a property which it does not exhibit or only incompletely exhibits in untreated form, e.g. color or improved stability to oxidation or UV radiation, but also resistance to wood-destroying microorganisms or insects. The effect substances are accordingly in particular colorants, including dyes and pigments, UV stabilizers, antioxidants, fungicides and/or insecticides.

The effect substance is, according to the invention, used in the form of a liquid preparation comprising the effect substance in dissolved or dispersed or suspended form. The liquid preparation of the effect substance can be solvent-based or water-based, water-based preparations being preferred. Solvent-based means, in this connection, that the liquid constituents of the composition essentially, i.e. to at least 60% by weight, based on the liquid constituents, comprise organic solvents. Water-based means, in this connection, that the liquid constituents of the composition essentially, i.e. to at least 60% by weight, in particular to at least 80% by weight, based on the liquid constituents, comprise water. Water-based preparations are preferred according to the invention.

In order to achieve uniform impregnation of the effect substance into the lignocellulose material, it is advantageous for the effect substance to be present in the composition, in particular in the aqueous composition, in dissolved or dispersed form with particle sizes of not more than 2000 nm and in particular not more than 1000 nm.

According to a preferred embodiment of the invention, the composition used in step a) is a water-based composition comprising at least one pigment dispersed in the aqueous phase and/or one dispersed effect substance with a mean particle size in the range from 50 to 2000 nm and in particular 50 to 1000 nm.

In this connection, it has proven to be advantageous for this composition to comprise at least one anionic polymeric dispersant. The use of such compositions for the impregnation of lignocellulose materials is novel and the present invention likewise relates to it. With these compositions, a particularly uniform dyeing is achieved, not only with finely divided or thin materials, such as veneers, but also with solid wood exhibiting minimum sizes of greater than 5 mm, in particular of greater than 10 mm. In particular, depths of penetration >10 mm or >20 mm are achieved and accordingly uniform impregnation is achieved, even of very large sections of wood with minimum sizes of 40 mm or more.

Both anionically modified polyurethanes and anionic homo- and copolymers of monoethylenically unsaturated monomers are suitable as anionic polymeric dispersants. The anionic groups can be phosphate, phosphonate, carboxylate or sulfonate groups, it also being possible for these groups to be present in the acid form. If the acid groups are present in neutralized form, these polymers exhibit appropriate counterions. Typical counterions are cations of alkali metals, such as sodium, potassium or lithium, and also ammonium or protonated primary, secondary or tertiary amines.

The molecular weight of the polymeric anionic dispersants typically ranges from 800 to 100 000 daltons, in particular from 1000 to 20 000 daltons (number-average molecular weight Mₙ), or from 1000 to 250 000 and in particular from 1800 to 100 000 (weight-average molecular weight M_{w}).

According to a first preferred embodiment, the anionic dispersant is a homo- or copolymer of monoethylenically unsaturated carboxylic acids, in particular a homo- or copolymer of monoethylenically unsaturated monocarboxylic acids and/or ethylenically unsaturated dicarboxylic acids, which can additionally comprise copolymerized neutral vinyl monomers as comonomers, or the alkoxylated products thereof, including the salts.

Examples of the monoethylenically unsaturated monomers comprising carboxyl groups are
monocarboxylic acids, such as acrylic acid, methacrylic acid and crotonic acid;
dicarboxylic acids, such as maleic acid, maleic anhydride, maleic acid monoester, maleic acid monoamide, reaction products of maleic acid with diamines, which can be oxidized to give derivatives comprising amine oxide groups, and fumaric acid; maleic acid, maleic anhydride and maleic acid monoamide being preferred.

Suitable neutral comonomers are in particular monoethylenically unsaturated neutral monomers, e.g.:
vinylaromatic compounds, such as styrene, methylstyrene and vinyltoluene;
olefins and dienes, such as ethylene, propylene, isobutene, diisobutene and butadiene;
vinyl ethers, such as polyethylene glycol monovinyl ether and octadecyl vinyl ether;
vinyl esters of linear or branched aliphatic monocarboxylic acids, such as vinyl acetate, vinyl propionate, vinyl laurate, vinyl stearate and vinyl versatate;
alkyl esters, cycloalkyl esters and aryl esters of monoethylenically unsaturated monocarboxylic acids, in particular acrylic acid and methacrylic acid esters, such as methyl, ethyl, propyl, isopropyl, butyl, pentyl, hexyl, 2-ethylhexyl, nonyl, lauryl and hydroxyethyl (meth)acrylate, and also phenyl, naphthyl and benzyl (meth)acrylate;
dialkyl esters of monoethylenically unsaturated dicarboxylic acids, such as dimethyl, diethyl, dipropyl, diisopropyl, dibutyl, dipentyl, dihexyl, di(2-ethylhexyl), dinonyl, dilauryl and di(2-hydroxyethyl) maleate and fumarate; or vinylpyrrolidone;
acrylonitrile and methacrylonitrile,
   styrene, isobutene, diisobutene, acrylic acid esters and polyethylene glycol monovinyl ethers being preferred comonomers.

Mention may in particular be made, as examples of preferred homopolymers, of polyacrylic acids.

The copolymers of the abovementioned monomers can be constructed from two or more, in particular three, different monomers. They can be random copolymers, alternating copolymers, block copolymers and graft copolymers. Mention may be made, as preferred copolymers, of styrene/acrylic acid, acrylic acid/maleic acid, acrylic acid/methacrylic acid, butadiene/acrylic acid, isobutene/maleic acid, diisobutene/maleic acid and styrene/maleic acid copolymers, which in each case may comprise acrylic acid esters and/or maleic acid esters as additional monomer constituents.

Preferably, the carboxyl groups of the non-alkoxylated homo- and copolymers are present at least partially in the salt form, in order to ensure solubility in water. The alkali metal salts, such as sodium and potassium salts, and the ammonium salts are suitable, for example.

The non-alkoxylated dispersants usually exhibit average molecular weights M_{w} of 1000 to 250000 (weight-average molecular weights). The molecular weight ranges particularly suitable for the individual polymers naturally depend on the composition thereof. Molecular weight details are given below, by way of example, for various polymers: polyacrylic acids: M_{w} of 900 to 250000; styrene/acrylic acid copolymers: M_{w} of 1000 to 50000; acrylic acid/methacrylic acid copolymers: M_{w} of 1000 to 250000; acrylic acid/maleic acid copolymers: M_{w} of 2000 to 70000.

In addition to these homo- and copolymers alone, their alkoxylation products are also suitable and preferred as anionic polymeric dispersants. These are to be understood as including above all the polymers partially esterified with poly-C₂-C₃-alkylene ether alcohols. The degree of esterification of these polymers is generally 30 to 80 mol %.

Poly-C₂-C₃-alkylene ether alcohols alone, preferably polyethylene glycols and polyethylene/propylene glycols, and their derivatives closed by end groups at one end, above all the corresponding monoethers, such as monoaryl ethers, e.g. monophenyl ethers, and in particular mono-C₁-C₂₆-alkyl ethers, e.g. ethylene and propylene glycols etherified with fatty alcohols, and polyether amines, which can be prepared, e.g., by conversion of a terminal OH group of the corresponding polyether alcohols or by polyaddition of alkylene oxides to preferably primary aliphatic amines, are suitable in particular for the esterification. Polyethylene glycols, polyethylene glycol monoethers and polyether amines are preferred in this connection. The average molecular weights Mₙ of the polyether alcohols and the derivatives thereof used are usually from 200 to 10000.

Such anionic surface-active additives are likewise known and are available commercially, e.g. under the names Sokalan® (BASF), Joncryl® (Johnson Polymer), Alcosperse® (Alco), Geropon® (Rhodia), Good-Rite® (Goodrich), Neoresin® (Avecia), Orotan® and Morez® (Rohm & Haas), Disperbyk® (Byk) and Tegospers® (Goldschmidt).

In an additional preferred embodiment, the water-based composition of a dispersed effect substance comprises at least one dispersant based on water-soluble or water-dispersible polyurethanes, in particular based on a polyether urethane, which is non-anionically or anionically modified. These are to be understood as including water-soluble or water-dispersible reaction products of polyvalent isocyanates (I), e.g. di- or triisocyanates, with polyfunctional, in particular difunctional, compounds RI which react with isocyanate, these compounds, if appropriate, exhibiting anionic groups, in particular carboxyl groups. The molecular weight of the water-soluble/water-dispersible polyurethanes typically ranges from 1000 to 250000 (weight-average molecular weights).

Diisocyanates are suitable in particular as polyvalent isocyanates I, it also being possible for these diisocyanates to be used in combination with compounds with three or four isocyanate groups.

Examples of preferred compounds I are: 2,4-toluylene diisocyanate (2,4-TDI), 4,4′-diphenylmethane diisocyanate (4,4′-MDI), para-xylylene diisocyanate, 1,4-diisocyanatobenzene, tetramethylxylylene diisocyanate (TMXDI), 2,4′-diphenylmethane diisocyanate (2,4′-MDI) and triisocyanatotoluene, as well as isophorone diisocyanate (IPDI), 2-butyl-2-ethylpentamethylene diisocyanate, tetramethylene diisocyanate, hexamethylene diisocyanate, dodecamethylene diisocyanate, 2,2-bis(4-isocyanatocyclohexyl)propane, trimethylhexane diisocyanate, 2-isocyanatopropylcyclohexyl isocyanate, 2,4,4- and 2,2,4-trimethylhexamethylene diisocyanate, 2,4′-methylenebis(cyclohexane) diisocyanate, cis-1,4-cyclohexane diisocyanate, trans-1,4-cyclohexane diisocyanate and 4-methyl-1,3-cyclohexane diisocyanate (H-TDI), and their mixtures.

All compounds with at least two functional groups which react with isocyanate groups with the formation of a bond, e.g. hydroxyl groups, primary amino groups and SH groups, are suitable in principle as organic compounds (RI) which react with isocyanate. Preferred compounds RI exhibit two hydroxyl groups per molecule. The compounds RI can also be used in combination with compounds RI′ which exhibit only one group which reacts with isocyanate, e.g. one hydroxyl group per molecule.

Examples of compounds RI are polyether diols, polyester diols, polylactone diols (lactone-based polyester diols), polycarbonate diols, diols and triols having up to 12 carbon atoms, dihydroxycarboxylic acids, dihydroxysulfonic acids and dihydroxyphosphonic acids.

Suitable polyether diols are, for example, homo- and copolymers of C₂-C₄-alkylene oxides, such as ethylene oxide, propylene oxide and butylene oxide, tetrahydrofuran, styrene oxide and/or epichlorohydrin. Preferred polyether diols are polyethylene glycol, polypropylene glycol, poly(ethylene oxide-co-propylene oxide), polybutylene glycol and polytetrahydrofuran. The molecular weight Mₙ of the polyether diols is preferably 250 to 5000, particularly preferably 500 to 2500.

Suitable polyester diols are in particular OH-terminated reaction products of diols with dicarboxylic acids. Examples of suitable dicarboxylic acids are aliphatic dicarboxylic acids with preferably 3 to 12 carbon atoms, such as succinic acid, glutaric acid, adipic acid, suberic acid, azelaic acid, sebacic acid, 1,12-dodecanedicarboxylic acid, maleic acid, fumaric acid or itaconic acid, and aromatic and cycloaliphatic dicarboxylic acids, such as phthalic acid, isophthalic acid phthalic anhydride, tetrahydrophthalic anhydride, hexahydrophthalic anhydride, tetrachlorophthalic anhydride or endomethylenetetrahydrophthalic anhydride or terephthalic acid. It is also possible, instead of dicarboxylic acids, to use their esters, in particular their methyl esters, or their anhydrides, such as maleic anhydride, phthalic anhydride, tetrahydrophthalic anhydride, hexahydrophthalic anhydride, tetrachlorophthalic anhydride or endomethylenetetrahydrophthalic anhydride. Suitable diols are in particular saturated and unsaturated aliphatic and cycloaliphatic diols. The particularly preferred aliphatic α,ω-dioles are unbranched and exhibit 2 to 12, in particular 2 to 8, above all 2 to 4, carbon atoms. Preferred cycloaliphatic diols are derived from cyclohexane. Examples of particularly suitable diols are: ethylene glycol, propylene glycol, 1,3-propanediol, 1,4-butanediol, 2-methylpropane-1,3 diol, 1,5-pentanediol, neopentyl glycol, 1,6-hexanediol, 1,8-octanediol, 1,10-decanediol, 1,12-dodecanediol, cis- and trans-but-2-ene-1,4-diol, 2-butyne-1,4-diol and cis- and trans-1,4-di(hydroxymethyl)cyclohexane. The molecular weight Mₙ of the polyester diols is preferably from 300 to 5000.

As compound RI reactive with isocyanate, suitable lactone-based polyester diols are aliphatic saturated unbranched ω-hydroxycarboxylic acids with 4 to 22, preferably 4 to 8 carbon atoms, preferably, e.g., reaction products of γ-hydroxybutyric acid and δ-hydroxyvaleric acid.

The abovementioned diols, in particular saturated and unsaturated aliphatic and cycloaliphatic diols, the same preferences as above being valid, are furthermore suitable as compounds reactive with isocyanate.

Likewise suitable as compounds RI reactive with isocyanate are polyols with more than 2 OH groups, e.g. triols, exhibiting in particular 3 to 12, above all 3 to 8, carbon atoms. An example of a particularly suitable triol is trimethylolpropane.

Anionically modified polyurethanes naturally exhibit anionic groups as mentioned above, in particular carboxyl groups. Such groups are suitably incorporated in the polyurethane during the preparation by means of compounds RI′ which react with isocyanate, which compounds RI′ additionally exhibit at least one anionic group.

Suitable compounds of this type are dihydroxycarboxylic acids, for example aliphatic saturated dihydroxycarboxylic acids, preferably exhibiting 4 to 14 carbon atoms. A particularly preferred example of these dihydroxycarboxylic acids is dimethylolpropionic acid (DMPA). Corresponding dihydroxysulfonic acids and dihydroxyphosphonic acids, such as 2,3-dihydroxypropanephosphonic acid, are furthermore suitable.

The introduction of anionic groups into the polyurethane can also be carried out by the use of compounds which react with isocyanate which exhibit only one group which reacts with isocyanate and at least one anionic group. Mention may be made, as examples, of in particular aliphatic, cycloaliphatic, araliphatic or aromatic monohydroxycarboxylic acids and monohydroxysulfonic acids.

The polyurethane-based dispersants are prepared by reaction of the compounds 1, RI and, if appropriate, RI′, the molar ratio of isocyanate groups to hydroxyl groups generally being 2:1 to 1:2, preferably 1.2:1 to 1:1.2. In particular, the anionic polyurethane exhibits no free isocyanate groups.

Such surface-active polyurethanes are known and are available commercially, e.g. under the name Borchi® GEN SN95 (Borchers).

Preferred aqueous preparations of the dispersed effect substance comprise at least one anionic dispersant and/or one polyurethane.

It can be advantageous for the aqueous preparation of the dispersed effect substance to additionally comprise at least one additional surface-active substance. In this connection, it is preferably a nonionic, water-soluble surface-active substance with a polyether structure, in particular those with one or more polyethylene oxide groups. Examples suitable for this are homo- and copolymers of C₂-C₄-alkylene oxides, in particular polyethylene oxides, polypropylene oxides, or poly(ethylene oxide-co-propylene oxide)s, copolymers of C₂-C₄-alkylene oxides with styrene oxide, in particular block copolymers with polypropylene oxide and polyethylene oxide blocks or block copolymers with poly(phenylethylene oxide) and polyethylene oxide blocks, and random copolymers of these alkylene oxides.

Also suitable are poly-C₂-C₄-alkylene oxides, in particular polyethylene oxides, polypropylene oxides and poly(ethylene oxide-co-propylene oxide)s, which are prepared by reaction of corresponding C₂-C₄-alkylene oxides with mono- or polyfunctional initiators, such as with saturated or unsaturated aliphatic and aromatic alcohols, such as phenol or naphthol, which in each case can for their part be substituted by alkyl, in particular C₁-C₁₂-alkyl, preferably C₄-C₁₂- or C₁-C₄-alkyl, saturated or unsaturated aliphatic and aromatic amines, or saturated or unsaturated aliphatic carboxylic acids and carboxamides. 1 to 300 mol, preferably 3 to 150 mol, of alkylene oxide per mole of initiator are normally used.

Suitable aliphatic alcohols in this connection generally comprise 6 to 26 carbon atoms, preferably 8 to 18 carbon atoms, and can be unbranched, branched or cyclic in structure. Mentioned may be made, as examples, of octanol, nonanol, decanol, isodecanol, undecanol, dodecanol, 2-butyloctanol, tridecanol, isotridecanol, tetradecanol, pentadecanol, hexadecanol (cetyl alcohol), 2-hexyldecanol, heptadecanol, octadecanol (stearyl alcohol), 2-heptylundecanol, 2-octyldecanol, 2-nonyltridecanol, 2-decyltetradecanol, oleyl alcohol and 9-octadecenol, and also mixtures of these alcohols, such as C₈/C₁₀-, C₁₃/C₁₅- and C₁₆/C₁₈-alcohols, and cyclopentanol and cyclohexanol. Of particular interest are the saturated and unsaturated fatty alcohols obtained by lipolysis and reduction from natural raw materials and the synthetic fatty alcohols from the oxo synthesis. The alkylene oxide adducts of these alcohols usually exhibit average molecular weights Mₙ of 200 to 5000.

Mention may be made, as examples of the abovementioned aromatic alcohols, in addition to unsubstituted phenol and α- and β-naphthol, of hexylphenol, heptylphenol, octylphenol, nonylphenol, isononylphenol, undecylphenol, dodecylphenol, di- and tributylphenol and dinonylphenol.

Suitable aliphatic amines correspond to the aliphatic alcohols listed above. The saturated and unsaturated fatty amines preferably exhibiting 14 to 20 carbon atoms also have particular importance here. Mention may be made, as aromatic amines, for example, of aniline and its derivatives.

Saturated and unsaturated fatty acids preferably comprising 14 to 20 carbon atoms and hydrogenated, partially hydrogenated and nonhydrogenated resin acids, and also polyvalent carboxylic acids, e.g. dicarboxylic acids, such as maleic acid, are suitable in particular as aliphatic carboxylic acids.

Suitable carboxamides are derived from these carboxylic acids.

In addition to the alkylene oxide adducts with the monovalent amines and alcohols, the alkylene oxide adducts with at least bifunctional amines and alcohols are of very particular interest.

Divalent to pentavalent amines corresponding in particular to the formula H₂N—(R¹—NR²)ₙ—H (R¹: C₂-C₆-alkylene; R²: hydrogen or C₁-C₆-alkyl; n: 1 to 5, it being possible for n to be identical or different) are preferred as at least bifunctional amines. Mention may specifically be made, for example, of: ethylenediamine, diethylenetriamine, triethylenetetramine, tetraethylenepentamine, 1,3-propylenediamine, dipropylenetriamine, 1,4,8-triazaoctane, 1,5,8,12-tetra azadodecane, hexamethylenediamine, dihexamethylenetriamine, 1,6-bis(3-aminopropylamino)hexane and N-methyldipropylenetriamine and polyethylenimine (Lupasol® brands of BASF), hexamethylenediamine and diethylenetriamine being particularly preferred and ethylenediamine being very particularly preferred.

These amines are preferably reacted first with propylene oxide and subsequently with ethylene oxide. The content of ethylene oxide in the block copolymers is usually from approximately 10 to 90% by weight.

The block copolymers based on polyvalent amines generally exhibit average molecular weights Mₙ of 1000 to 40000, preferably 1500 to 30000.

Divalent to pentavalent alcohols are preferred as at least bifunctional alcohols. Mention may be made, by way of examples, of C₂-C₆-alkylene glycols and the corresponding di- and polyalkylene glycols, such as ethylene glycol, 1,2- and 1,3-propylene glycol, 1,2- and 1,4-butylene glycol, 1,6-hexylene glycol, dipropylene glycol and polyethylene glycol, glycerol and pentaerythritol, ethylene glycol and polyethylene glycol being particularly preferred and propylene glycol and dipropylene glycol being very particularly preferred.

Particularly preferred alkylene oxide adducts of at least bifunctional alcohols exhibit a central polypropylene oxide block, thus start from a propylene glycol or polypropylene glycol, which is first reacted with additional propylene oxide and then with ethylene oxide. The content of ethylene oxide in the block copolymers is usually from 10 to 90% by weight.

The block copolymers based on polyvalent alcohols generally exhibit average molecular weights Mₙ of 1000 to 20000, preferably 1000 to 15000. Such alkylene oxide block copolymers are known and are available commercially, e.g. under the names Tetronic® and Pluronic® (BASF).

The nonionic surface-active substances also include low molecular weight substances which typically exhibit a molecular weight (number-average molecular weight) of less than 1500 daltons and frequently of less than 800 daltons and which are subsequently also described as nonionic emulsifiers. Nonionic emulsifiers are known to a person skilled in the art, e.g. from Ullmann's Encyclopedia of Industrial Chemistry, 5th ed. on CD-ROM, Wiley-VCH, Weinheim, 1997, Emulsifiers, Chapter 7.

Examples of nonionic emulsifiers are in particular ethoxylated C₈-C₂₀-alkanols with degrees of ethoxylation in the range from 3 to 50 and especially 5 to 30, and also ethoxylated C₄-C₂₀-alkylphenols with degrees of ethoxylation in the range from 3 to 50 and especially 5 to 30.

In addition, the surface-active substances can also include, in lesser amount, low molecular weight anionic emulsifiers. These include in particular emulsifiers on the basis of acidic phosphoric acid, phosphonic acid, sulfuric acid and/or sulfonic acid esters of C₆-C₂₀-alkanols, C₄-C₂₀-alkylphenols, ethoxylated C₆-C₂₀-alkanols and ethoxylated C₄-C₂₀-alkylphenols, furthermore on the basis of the abovementioned reaction products of the above-listed polyethers with phosphoric acid, phosphorus pentoxide and phosphonic acid or sulfuric acid and sulfonic acid. In this connection, the polyethers are converted into the corresponding phosphoric acid mono- or diesters and phosphonic acid esters or the sulfuric acid monoesters and sulfonic acid esters. These acidic esters are preferably present in the form of water-soluble salts, in particular as alkali metal salts, above all sodium salts, and ammonium salts; however, they can also be used in the form of the free acids.

Preferred phosphates and phosphonates are derived above all from alkoxylated, in particular ethoxylated, fatty and oxo alcohols, alkylphenols, fatty amines, fatty acids and resin acids. Preferred sulfates and sulfonates are based in particular on alkoxylated, above all ethoxylated, fatty alcohols, alkylphenols and amines, also polyvalent amines, such as hexamethylenediamine.

Such anionic surface-active additives are known and are available commercially, e.g. under the names Nekal® (BASF), Tamol® (BASF), Crodafos® (Croda), Rhodafac® (Rhodia), Maphos® (BASF), Texapon® (Cognis), Empicol® (Albright & Wilson), Matexil® (ICI), Soprophor® (Rhodia) and Lutensit® (BASF).

The proportion of the abovementioned polymeric dispersants generally constitutes 5 to 100% by weight, based on the dispersed solid, and in particular 10 to 80% by weight, based on the dispersed solid.

In a first preferred embodiment of the invention, the composition used in step a) comprises at least one colorant, in particular a pigment, if appropriate in combination with one or more additional effect substances, in particular a soluble dye.

Examples of suitable organic coloring pigments are:

| | |
|---|---|
| Monoazo | C.I. Pigment Brown 25; |
| pigments: | C.I. Pigment Orange 5, 13, 36, 38, 64 and 67; |
| | C.I. Pigment Red 1, 2, 3, 4, 5, 8, 9, 12, 17, 22, |
| | 23, 31, 48:1, 48:2, 48:3, 48:4, 49, 49:1, 51:1, 52:1, 52:2, |
| | 53, 53:1, 53:3, 57:1, 58:2, 58:4, 63, 112, 146, 148, 170, |
| | 175, 184, 185, 187, 191:1, 208, 210, 245, 247 and 251; |
| | C.I. Pigment Yellow 1, 3, 62, 65, 73, 74, 97, 120, 151, |
| | 154, 168, 181, 183 and 191; C.I. Pigment Violet 32; |
| Disazo | C.I. Pigment Orange 16, 34, 44 and 72; |
| pigments: | C.I. Pigment Red 144, 166, 214, 220, 221 and 242; |
| | C.I. Pigment Yellow 12, 13, 14, 16, 17, 81, 83, 106, 113, |
| | 126, 127, 155, 174, 176, 180 and 188; |
| Disazo | C.I. Pigment Yellow 93, 95 and 128; |
| condensation | C.I. Pigment Red 144, 166, 214, 220, 242 and 262; |
| pigments: | C.I. Pigment Brown 23 and 41; |
| Anthanthrone | C.I. Pigment Red 168; |
| pigments: | |
| Anthra- | C.I. Pigment Yellow 147, 177 and 199; |
| quinone | C.I. Pigment Violet 31; |
| pigments: | |
| Anthra- | C.I. Pigment Yellow 108; |
| pyrimidine | |
| pigments: | |
| Quinacridone | C.I. Pigment Orange 48 and 49; |
| pigments: | C.I. Pigment Red 122, 202, 206 and 209; |
| | C.I. Pigment Violet 19; |
| Quin- | C.I. Pigment Yellow 138; |
| ophthalone | |
| pigments: | |
| Diketopyr- | C.I. Pigment Orange 71, 73 and 81; |
| rolopyrrole | C.I. Pigment Red 254, 255, 264, 270 and 272; |
| pigments: | |
| Dioxazine | C.I. Pigment Violet 23 and 37; |
| pigments: | C.I. Pigment Blue 80; |
| Flavanthrone | C.I. Pigment Yellow 24; |
| pigments: | |
| Indanthrone | C.I. Pigment Blue 60 and 64; |
| pigments: | |
| Isoindoline | C.I. Pigmente Orange 61 and 69; |
| pigments: | C.I. Pigment Red 260; |
| | C.I. Pigment Yellow 139 and 185; |
| Isoindol- | C.I. Pigment Yellow 109, 110 and 173; |
| inone | |
| pigments: | |
| Isoviol- | C.I. Pigment Violet 31; |
| anthrone | |
| pigments: | |
| Metal | C.I. Pigment Red 257; |
| complex | C.I. Pigment Yellow 117, 129, 150, 153 and 177; |
| pigments: | C.I. Pigment Green 8; |
| Perinone | C.I. Pigment Orange 43; |
| pigments: | C.I. Pigment Red 194; |
| Perylene | C.I. Pigment Black 31 and 32; |
| pigments: | C.I. Pigment Red 123, 149, 178, 179, 190 and 224; |
| | C.I. Pigment Violet 29; |
| Phthalo- | C.I. Pigment Blue 15, 15:1, 15:2, |
| cyanine | 15:3, 15:4, 15:6 and 16; |
| pigments: | C.I. Pigment Green 7 and 36; |
| Pyranthrone | C.I. Pigment Orange 51; |
| pigments: | C.I. Pigment Red 216; |
| Pyrazolo- | C.I. Pigment Orange 67; |
| quinazolone | C.I. Pigment Red 251; |
| pigments: | |
| Thioindigo | C.I. Pigment Red 88 and 181; |
| pigments: | C.I. Pigment Violet 38; |
| Triaryl- | C.I. Pigment Blue 1, 61 and 62; |
| carbonium | C.I. Pigment Green 1; |
| pigments: | C.I. Pigment Red 81, 81:1 and 169; |
| | C.I. Pigment Violet 1, 2, 3 and 27; |

C.I. Pigment Black 1 (aniline black);
C.I. Pigment Yellow 101 (aldazine yellow);
C.I. Pigment Brown 22.

Suitable inorganic coloring pigments are, e.g.:

| | |
|---|---|
| White | titanium dioxide (C.I. Pigment White 6), zink white, leaded |
| pigments: | zinc oxide, zinc sulfide, lithopone; |
| Black | black iron oxide (C.I. Pigment Black 11), |
| pigments: | iron manganese black, spinel black (C.I. Pigment Black |
| | 27), carbon black (C.I. Pigment Black 7); |
| Colored | chromium oxide, hydrated chrome oxide green, chrome |
| pigments: | green (C.I. Pigment Green 48), cobalt green (C.I. Pigment |
| | Green 50), ultramarine green; |
| | cobalt blue (C.I. Pigment Blue 28 and 36, C.I. Pigment |
| | Blue 72), ultramarine blue, manganese blue; |
| | ultramarine violet, cobalt violet and manganese violet; |
| | red iron oxide (C.I. Pigment Red 101), cadmium |
| | sulfoselenide (C.I. Pigment Red 108), cerium sulfide (C.I. |
| | Pigment Red 265), molybdate red (C.I. Pigment Red 104), |
| | ultramarine red; |
| | brown iron oxide (C.I. Pigment Brown 6 and 7), mixed |
| | brown, spinel and corundum phases (C.I. Pigment Brown |
| | 29, 31, 33, 34, 35, 37, 39 and 40), chrome rutile yellow |
| | (C.I. Pigment Brown 24), chrome orange; |
| | cerium sulfide (C.I. Pigment Orange 75); |
| | yellow iron oxide (C.I. Pigment Yellow 42), nickel rutile |
| | yellow (C.I. Pigment Yellow 53, C.I. Pigment Yellow 157, |
| | 158, 159, 160, 161, 162, 163, 164 and 189), chromium |
| | rutile yellow, spinel phases (C.I. Pigment Yellow 119), |
| | cadmium sulfide and cadmium zinc sulfide (C.I. Pigment |
| | Yellow 37 and 35), chrome yellow (C.I. Pigment Yellow |
| | 34), bismuth vanadate (C.I. Pigment Yellow 184). |

Preferred dyes are those which are soluble in water or an organic solvent which is miscible with water or is soluble in water. If pigment and dye are used together, they preferably exhibit a hue which is comparable each time, since in this way a particularly rich coloring of the lignocellulose materials can be achieved. However, soffening dyes can also be used in the hue, which makes possible shadings of the coloring. Cationic and anionic dyes are suitable in particular.

Suitable cationic dyes originate in particular from the di- and triarylmethane, xanthene, azo, cyanine, azacyanine, methine, acridine, safranine, oxazine, induline, nigrosine and phenazine series, dyes from the azo, triarylmethane and xanthene series being preferred. Specific examples which may be listed are: C.I. Basic Yellow 1, 2 and 37, C.I. Basic Orange 2, C.I. Basic Red 1 and 108, C.I. Basic Blue 1, 7 and 26, C.I. Basic Violet 1, 3, 4, 10, 11 and 49, C.I. Basic Green 1 and 4, C.I. Basic Brown 1 and 4. Cationic dyes (B) can also be colorants comprising external basic groups. Suitable examples are, in this connection, C.I. Basic Blue 15 and 161. Use may also be made, as cationic dyes (B), of the corresponding dye bases in the presence of solubilizing acidic agents. Mention may be made, by way of examples, of: C.I. Solvent Yellow 34, C.I. Solvent Orange 3, C.I. Solvent Red 49, C.I. Solvent Violet 8 and 9, C.I. Solvent Blue 2 and 4, C.I. Solvent Black 7.

Suitable anionic dyes are in particular compounds comprising sulfonic acid groups from the series of the azo, anthraquinone, metal complex, triarylmethane, xanthene and stilbene series, dyes from the triarylmethane, azo and metal complex (above all copper, chromium and cobalt complex) series being preferred. Specific examples which may be mentioned are: C.I. Acid Yellow 3, 19, 36 and 204, C.I. Acid Orange 7, 8 and 142, C.I. Acid Red 52, 88, 351 and 357, C.I. Acid Violet 17 and 90, C.I. Acid Blue 9, 193 and 199, C.I. Acid Black 194, anionic chromium complex dyes, such as C.I. Acid Violet 46, 56, 58 and 65, C.I. Acid Yellow 59, C.I. Acid Orange 44, 74 and 92, C.I. Acid Red 195, C.I. Acid Brown 355 and C.I. Acid Black 52, anionic cobalt complex dyes, such as C.I. Acid Yellow 119 and 204, C.I. Direct Red 80 and 81.

Water-soluble dyes are preferred.

UV absorbers, antioxidants and/or stabilizers can also be used as effect substances. Examples of UV absorbers are the compounds from the groups a) to g) listed below. Examples of stabilizers are the compounds from the groups i) to q) listed below:

a) 4,4-diarylbutadienes,

b) cinnamates,

c) benzotriazoles,

d) hydroxybenzophenones,

e) diphenylcyanoacrylates,

f) oxamides,

g) 2-phenyl-1,3,5-triazines,

h) antioxidants,

i) sterically hindered amines,

j) metal deactivators,

k) phosphites and phosphonites,

l) hydroxylamines,

m) nitrones,

n) amine oxides,

o) benzofuranones and indolinones,

p) thiosynergists, and

q) peroxide-destroying compounds.

The group a) of 4,4-diarylbutadienes includes, for example, compounds of the formula A.

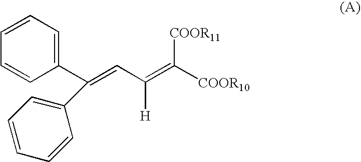

The compounds are known from EP-A-916 335. The R₁₀ and/or R₁₁ substituents preferably represent C₁-C₈-alkyl and C₅-C₈-cycloalkyl.

The group b) of the cinnamates includes, for example, 2-isoamyl 4-methoxycinnamate, 2-ethyihexyl 4-methoxycinnamate, methyl α-(methoxycarbonyl)cinnamate, methyl α-cyano-β-methyl-p-methoxycinnamate, butyl α-cyano-β-methyl-p-methoxycinnamate and methyl α-(methoxycarbonyl)-p-methoxycinnamate.

The group c) of the benzotriazoles includes, for example, 2-(2′-hydroxyphenyl)benzotriazoles, such as 2-(2′-hydroxy-5′-methylphenyl)benzotriazole, 2-(3′,5′-di(tert-butyl)-2′-hydroxyphenyl)benzotriazole, 2-(5′-(tert-butyl)-2′-hydroxyphenyl)benzotriazole, 2-(2′-hydroxy-5′-(1,1,3,3-tetramethylbutyl)phenyl)benzotriazole, 2-(3′,5′-di(tert-butyl)-2′-hydroxyphenyl)-5-chlorobenzotriazole, 2-(3′-(tert-butyl)-2′-hydroxy-5′-methylphenyl)-5-chlorobenzotriazole, 2-(3′-(sec-butyl)-5′-(tert-butyl)-2′-hydroxyphenyl)benzotriazole, 2-(2′-hydroxy-4′-octyloxyphenyl)benzotriazole, 2-(3′,5′-di(tert-amyl)-2′-hydroxyphenyl)benzotriazole, 2-(3′,5′-bis(α,α-dimethylbenzyl)-2′-hydroxyphenyl)benzotriazole, 2-(3′-(tert-butyl)-2′-hydroxy-5′-(2-octyloxycarbonylethyl)phenyl)-5-chlorobenzotriazole, 2-(3′-(tert-butyl)-5′-[2-(2-ethylhexyloxycarbonyl)ethyl]-2′-hydroxyphenyl)-5-chlorobenzotriazole, 2-(3′-(tert-butyl)-2′-hydroxy-5′-(2-methoxycarbonylethyl)phenyl)-5-chlorobenzotriazole, 2-(3′-(tert-butyl)-2′-hydroxy-5′-(2-methoxycarbonylethyl)phenyl)benzotriazole, 2-(3′-(tert-butyl)-2′-hydroxy-5′-(2-octyloxycarbonylethyl)phenyl)benzotriazole, 2-(3′-(tert-butyl)-5′-[2-(2-ethylhexyloxy)carbonylethyl]-2′-hydroxyphenyl)benzotriazole, 2-(3′-dodecyl-2′-hydroxy-5′-methylphenyl)benzotriazole and 2-(3′-(tert-butyl)-2′-hydroxy-5′-(2-isooctyloxycarbonylethyl)phenyl)benzotriazole, 2,2′-methylenebis[4-(1,1,3,3-tetramethylbutyl)-6-(benzotriazol-2-yl)phenol], the product of the esterification of 2-[3′-(tert-butyl)-5′-(2-methoxycarbonylethyl)-2′-hydroxyphenyl]-2H-benzotriazole with polyethylene glycol 300, [R—CH₂CH₂—COO(CH₂)₃]₂ with R=3′-(tert-butyl)-4′-hydroxy-5′-(2H-benzotriazol-2-yl)phenyl, and mixtures thereof.

The group d) of the hydroxybenzophenones includes, for example, 2-hydroxybenzophenones, such as 2-hydroxy-4-methoxybenzophenone, 2,2′-dihydroxy-4-methoxybenzophenone, 2,4-dihydroxybenzophenone, 2,2′,4,4′-tetrahydroxybenzophenone, 2,2′-dihydroxy-4,4′-dimethoxybenzophenone, 2,2′-dihydroxy4,4′-dimethoxybenzophenone, 2-hydroxy-4-(2-ethylhexyloxy)benzophenone, 2-hydroxy-4-(n-octyloxy)benzophenone, 2-hydroxy-4-methoxy-4′-methylbenzophenone, 2-hydroxy-3-carboxybenzophenone, 2-hydroxy-4-methoxybenzophenone-5-sulfonic acid and its sodium salt, and 2,2′-dihydroxy-4,4′-dimethoxybenzophenone-5,5′-disulfonic acid and its sodium salt.

The group e) of the diphenylcyanoacrylates includes, for example, ethyl 2-cyano-3,3-diphenylacrylate, which is available, for example, commercially under the name Uvinul® 3035 from BASF AG, Ludwigshafen, 2-ethylhexyl 2-cyano-3,3-diphenylacrylate, which is available, for example, commercially as Uvinul® 3039 from BASF AG, Ludwigshafen, and 1,3-bis[(2′-cyano-3′,3′-diphenylacryloyl)oxy]-2,2-bis{[(2′-cyano-3′,3′-diphenylacryloyl)oxy]methyl}propane, which is available, for example, commercially under the name Uvinul® 3030 from BASF AG, Ludwigshafen.

The group f) of the oxamides includes, for example, 4,4′-dioctyloxyoxanilide, 2,2′-diethoxyoxanilide, 2,2′-dioctyloxy-5,5′-di(tert-butyl)oxanilide, 2,2′-didodecyloxy-5,5′-di(tert-butyl)oxanilide, 2-ethoxy-2′-ethyloxanilide, N,N′-bis(3-dimethylaminopropyl)oxamide, 2-ethyloxy-5-(tert-butyl)-2′-ethyloxanilide and its mixture with 2-ethoxy-2′-ethyl-5,4′-di(tert-butyl)oxanilide, and also mixtures of ortho- and para-methoxy-disubstituted oxanilides and mixtures of ortho- and para-ethoxy-disubstituted oxanilides.

The group g) of the 2-phenyl-1,3,5-triazines includes, for example, 2-(2-hydroxyphenyl)-1,3,5-triazines, such as 2,4,6-tris(2-hydroxy-4-octyloxyphenyl)-1,3,5-triazine, 2-(2-hydroxy-4-octyloxyphenyl)-4,6-bis(2,4-dimethylphenyl)-1,3,5-triazine, 2-(2,4-dihydroxyphenyl)-4,6-bis(2,4-dimethylphenyl)-1,3,5-triazine, 2,4-bis(2-hydroxy-4-propyloxyphenyl)-6-(2,4-dimethylphenyl)-1,3,5-triazine, 2-(2-hydroxy-4-octyloxyphenyl)-4,6-bis(4-methylphenyl)-1,3,5-triazine, 2-(2-hydroxy-4-dodecyloxyphenyl)-4,6-bis(2,4-dimethylphenyl)-1,3,5-triazine, 2-(2-hydroxy-4-tridecyloxyphenyl)-4,6-bis(2,4-dimethylphenyl)-1,3,5-triazine, 2-[2-hydroxy-4-(2-hydroxy-3-(butyloxy)propoxy)phenyl]-4,6-bis(2,4-dimethylphenyl)-1,3,5-triazine, 2-[2-hydroxy-4-(2-hydroxy-3-(octyloxy)propoxy)phenyl]-4,6-bis(2,4-dimethylphenyl)-1,3,5-triazine, 2-[4-(dodecyloxy/tridecyloxy-2-hydroxypropoxy)-2-hydroxyphenyl]-4,6-bis(2,4-dimethylphenyl)-1,3,5-triazine, 2-[2-hydroxy-4-(2-hydroxy-3-(dodecyloxy)propoxy)phenyl]-4,6-bis(2,4-dimethylphenyl)-1,3,5-triazine, 2-(2-hydroxy-4-hexyloxyphenyl)-4,6-diphenyl-1,3,5-triazine, 2-(2-hydroxy-4-methoxyphenyl)-4,6-diphenyl-1,3,5-triazine, 2,4,6-tris[2-hydroxy-4-(3-butoxy-2-hydroxypropoxy)phenyl]-1,3,5-triazine and 2-(2-hydroxyphenyl)-4-(4-methoxyphenyl)-6-phenyl-1,3,5-triazine.

The group h) of the antioxidants comprises, for example: alkylated monophenols, such as, for example, 2,6-di(tert-butyl)-4-methylphenol, 2-(tert-butyl)-4,6-dimethylphenol, 2,6-di(tert-butyl)-4-ethylphenol, 2,6-di(tert-butyl)-4-(n-butyl)phenol, 2,6-di(tert-butyl)-4-isobutylphenol, 2,6-dicyclopentyl-4-methylphenol, 2-(α-methylcyclohexyl)-4,6-dimethylphenol, 2,6-dioctadecyl-4-methylphenol, 2,4,6-tricyclohexylphenol, 2,6-di(tert-butyl)-4-methoxymethylphenol, unbranched nonylphenols or nonylphenols which are branched in the side chain, such as, for example, 2,6-dinonyl-4-methylphenol, 2,4-dimethyl-6-(1-methylundec-1-yl)phenol, 2,4-dimethyl-6-(1-methylheptadec-1-yl)phenol, 2,4-dimethyl-6-(1-methyltridec-1-yl)phenol and mixtures thereof.

Alkylthiomethylphenols, such as, for example, 2,4-dioctylthiomethyl-6-(tert-butyl)phenol, 2,4-dioctylthiomethyl-6-methylphenol, 2,4-dioctylthiomethyl-6-ethylphenol and 2,6-didodecylthiomethyl-4-nonylphenol.

Hydroquinones and alkylated hydroquinones, such as, for example, 2,6-di(tert-butyl)-4-methoxyphenol, 2,5-di(tert-butyl)hydroquinone, 2,5-di(tert-amyl)hydroquinone, 2,6-diphenyl-4-octadecyloxyphenol, 2,6-di(tert-butyl)hydroquinone, 2,5-di(tert-butyl)-4-hydroxyanisole, 3,5-di(tert-butyl)-4-hydroxyanisole, 3,5-di(tert-butyl)-4-hydroxyphenyl stearate and bis(3,5-di(tert-butyl)-4-hydroxyphenyl) adipate.

Tocopherols, such as, for example, α-tocopherol, β-tocopherol, γ-tocopherol, δ-tocopherol and mixtures thereof (vitamin E).

Hydroxylated thiodiphenyl ethers, such as, for example, 2,2′-thiobis(6-(tert-butyl)-4-methylphenol), 2,2′-thiobis(4-octylphenol), 4,4′-thiobis(6-(tert-butyl)-3-methylphenol), 4,4′-thiobis(6-(tert-butyl)-2-methylphenol), 4,4′-thiobis(3,6-di(sec-amyl)phenol) and 4,4′-bis(2,6-dimethyl-4-hydroxyphenyl) disulfide.

Alkylidenebisphenols, such as, for example, 2,2′-methylenebis(6-(tert-butyl)-4-methylphenol), 2,2′-methylenebis(6-(tert-butyl)-4-ethylphenol), 2,2′-methylenebis[4-methyl-6-(α-methylcyclohexyl)phenol], 2,2′-methylenebis(4-methyl-6-cyclohexylphenol), 2,2′-methylenebis(6-nonyl-4-methylphenol), 2,2′-methylenebis(4,6-di(tert-butyl)phenol), 2,2′-ethylidenebis(4,6-di(tert-butyl)phenol), 2,2′-ethylidenebis(6-(tert-butyl)-4-isobutylphenol), 2,2′-methylenebis[6-(α-methylbenzyl)-4-nonylphenol], 2,2′-methylenebis[6-(α,α-dimethylbenzyl)-4-nonylphenol], 4,4′-methylenebis(2,6-di(tert-butyl)phenol), 4,4′-methylenebis(6-(tert-butyl)-2-methylphenol), 1,1-bis(5-(tert-butyl)-4-hydroxy-2-methylphenyl)butane, 2,6-bis(3-(tert-butyl)-5-methyl-2-hydroxybenzyl)-4-methylphenol, 1,1,3-tris(5-(tert-butyl)-4-hydroxy-2-methylphenyl)butane, 1,1-bis(5-(tert-butyl)-4-hydroxy-2-methylphenyl)-3-(n-dodecylmercapto)butane, ethylene glycol bis[3,3-bis(3-(tert-butyl)-4-hydroxyphenyl)butyrate], bis(3-(tert-butyl)-4-hydroxy-5-methylphenyl)dicyclopentadiene, bis[2-(3′-(tert-butyl)-2-hydroxy-5-methylbenzyl)-6-(tert-butyl)-4-methylphenyl] terephthalate, 1,1-bis(3,5-dimethyl-2-hydroxyphenyl)butane, 2,2-bis(3,5-di(tert-butyl)-4-hydroxyphenyl)propane, 2,2-bis(5-(tert-butyl)-4-hydroxy-2-methylphenyl)-4-(n-dodecylmercapto)butane and 1,1,5,5-tetra(5-(tert-butyl)-4-hydroxy-2-methylphenyl)pentane.

Benzyl compounds, such as, for example, 3,5,3′,5′-tetra(tert-butyl)-4,4′-dihydroxydibenzyl ether, octadecyl 4-hydroxy-3,5-dimethylbenzylmercaptoacetate, tridecyl 4-hydroxy-3,5-di(tert-butyl)benzylmercaptoacetate, tris(3,5-di(tert-butyl)-4-hydroxybenzyl)amine, 1,3,5-tri(3,5-di(tert-butyl)-4-hydroxybenzyl)-2,4,6-trimethylbenzene, di(3,5-di(tert-butyl)-4-hydroxybenzyl) sulfide, isooctyl 3,5-di(tert-butyl)-4-hydroxybenzylmercaptoacetate, bis(4-(tert-butyl)-3-hydroxy-2,6-dimethylbenzyl) dithioterephthalate, 1,3,5-tris(3,5-di(tert-butyl)-4-hydroxybenzyl) isocyanurate, 1,3,5-tris(4-(tert-butyl)-3-hydroxy-2,6-dimethylbenzyl) isocyanurate, 3,5-di(tert-butyl)-4-hydroxybenzyl dioctadecyl phosphate and 3,5-di(tert-butyl)-4-hydroxybenzyl monoethyl phosphate, calcium salt.

Hydroxybenzylated malonates, such as, for example, dioctadecyl 2,2-bis(3,5-di(tert-butyl)-2-hydroxybenzyl)malonate, dioctadecyl 2-(3-(tert-butyl)-4-hydroxy-5-methylbenzyl)malonate, didodecylmercaptoethyl 2,2-bis(3,5-di(tert-butyl)-4-hydroxybenzyl)malonate and bis[4-(1,1,3,3-tetramethylbutyl)phenyl] 2,2-bis(3,5-di(tert-butyl)-4-hydroxybenzyl)malonate.

Hydroxybenzyl aromatic compounds, such as, for example, 1,3,5-tris(3,5-di(tert-butyl)-4-hydroxybenzyl)-2,4,6-trimethylbenzene, 1,4-bis(3,5-di(tert-butyl)-4-hydroxybenzyl)-2,3,5,6-tetramethylbenzene and 2,4,6-tris(3,5-di(tert-butyl)-4-hydroxybenzyl)phenol.

Triazine compounds, such as, for example, 2,4-bis(octylmercapto)-6-(3,5-di(tert-butyl)-4-hydroxyanilino)-1,3,5-triazine, 2-octylmercapto-4,6-bis(3,5-di(tert-butyl)-4-hydroxyanilino)-1,3,5-triazine, 2-octylmercapto-4,6-bis(3,5-di(tert-butyl)-4-hydroxyphenoxy)-1,3,5-triazine, 2,4,6-tris(3,5-di(tert-butyl)-4-hydroxyphenoxy)-1,3,5-triazine, 1,3,5-tris(3,5-di(tert-butyl)-4-hydroxybenzyl) isocyanurate, 1,3,5-tris(4-(tert-butyl)-3-hydroxy-2,6-dimethylbenzyl) isocyanurate, 2,4,6-tris(3,5-di(tert-butyl)-4-hydroxyphenylethyl)-1,3,5-triazine, 1,3,5-tris(3,5-di(tert-butyl)-4-hydroxyphenylpropionyl)-hexahydro-1,3,5-triazine and 1,3,5-tris(3,5-dicyclohexyl-4-hydroxybenzyl) isocyanurate.

Benzylphosphonates, such as, for example, dimethyl 2,5-di(tert-butyl)-4-hydroxybenzylphosphonate, diethyl 3,5-di(tert-butyl)-4-hydroxybenzyiphosphonate ((3,5-bis(1, 1-dimethylethyl)-4-hydroxyphenyl)methylphosphonic acid diethyl ester), dioctadecyl 3,5-di(tert-butyl)-4-hydroxybenzylphosphonate, dioctadecyl 5-(tert-butyl)-4-hydroxy-3-methylbenzylphosphonate and calcium salt of 3,5-di(tert-butyl)-4-hydroxybenzylphosphonic acid monoethyl ester.

Acylaminophenols, such as, for example, lauric acid 4-hydroxyanilide, stearic acid 4-hydroxyanilide, 2,4-bisoctylmercapto-6-(3,5-di(tert-butyl)-4-hydroxyanilino)-s-triazine and octyl N-(3,5-di(tert-butyl)-4-hydroxyphenyl)carbamate.

Esters of β-(3,5-di(tert-butyl)-4-hydroxyphenyl)propionic acid with mono- or polyvalent alcohols, such as, e.g., with methanol, ethanol, n-octanol, isooctanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl) isocyanurate, N,N′-bis(hydroxyethyl) oxalic acid diamide, 3-thiaundecanol, 3-thiapentadecanol, trimethylhexanediol, trimethylolpropane and 4-hydroxymethyl-1-phospha-2,6,7-trioxabicyclo[2.2.2]octane.

Esters of β-(5-(tert-butyl)-4-hydroxy-3-methylphenyl)propionic acid with mono- or polyvalent alcohols, such as, e.g., with methanol, ethanol, n-octanol, isooctanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl) isocyanurate, N,N′-bis(hydroxyethyl) oxalic acid diamide, 3-thiaundecanol, 3-thiapentadecanol, trimethylhexanediol, trimethylolpropane and 4-hydroxymethyl-1-phospha-2,6,7-trioxabicyclo[2.2.2] octane.

Esters of β-(3,5-dicyclohexyl-4-hydroxyphenyl)propionic acid with mono- or polyvalent alcohols, such as, e.g., with methanol, ethanol, octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl) isocyanurate, N,N′-bis(hydroxyethyl) oxalic acid diamide, 3-thiaundecanol, 3-thiapentadecanol, trimethylhexanediol, trimethylolpropane and 4-hydroxymethyl-1-phospha-2,6,7-trioxabicyclo[2.2.2]octane.

Esters of 3,5-di(tert-butyl)-4-hydroxyphenylacetic acid with mono- or polyvalent alcohols, such as, e.g., with methanol, ethanol, octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl) isocyanurate, N,N′-bis(hydroxyethyl) oxalic acid diamide, 3-thiaundecanol, 3-thiapentadecanol, trimethylhexanediol, trimethylolpropane and 4-hydroxymethyl-1-phospha-2,6,7-trioxabicyclo[2.2.2]octane.

Amides of β-(3,5-di(tert-butyl)-4-hydroxyphenyl)propionic acid, such as, e.g., N,N′-bis(3,5-di(tert-butyl)-4-hydroxyphenylpropionyl)hexamethylenediamine, N,N′-bis(3,5-di(tert-butyl)-4-hydroxyphenylpropionyl)trimethylenediamine, N,N′-bis(3,5-di(tert-butyl)-4-hydroxyphenylpropionyl)hydrazine and N,N′-bis[2-(3-[3,5-di(tert-butyl)-4-hydroxyphenyl]propionyloxy)ethyl]oxamide (e.g. Naugard® XL-1 from Uniroyal).

Ascorbic acid (vitamin C).

Aminic antioxidants, such as, for example, N,N′-diisopropyl-p-phenylenediamine, N,N′-di(sec-butyl)-p-phenylenediamine, N,N′-bis(1,4-dimethylpentyl)-p-phenylenediamine, N,N′-bis(1-ethyl-3-methylpentyl)-p-phenylenediamine, N,N′-bis(1-methylheptyl)-p-phenylenediamine, N,N′-dicyclohexyl-p-phenylenediamine, N,N′-diphenyl-p-phenylenediamine, N,N′-bis(2-naphthyl)-p-phenylenediamine, N-isopropyl-N′-phenyl-p-phenylenediamine, N-(1,3-dimethylbutyl)-N′-phenyl-p-phenylenediamine, N-(1-methylheptyl)-N′-phenyl-p-phenylenediamine, N-cyclohexyl-N′-phenyl-p-phenylenediamine, 4-(p-tolylsulfamoyl)diphenylamine, N,N′-dimethyl-N,N′-di(sec-butyl)-p-phenylenediamine, diphenylamine, N-allyldiphenylamine, 4-isopropoxy-diphenylamine, N-phenyl-1-naphthylamine, N-(4-(tert-octyl)phenyl)-1-naphthylamine, N-phenyl-2-naphthylamine, octylated diphenylamine, for example p,p′-di(tert-octyl)diphenylamine, 4-(n-butylamino)phenol, 4-butyrylaminophenol, 4-nonanoylaminophenol, 4-dodecanoylaminophenol, 4-octadecanoylaminophenol, bis(4-methoxyphenyl)amine, 2,6-di(tert-butyl)-4-dimethylaminomethylphenol, 2,4′-diaminodiphenylmethane, 4,4′-diaminodiphenylmethane, N,N,N′, N′-tetramethyl-4,4′-diaminodiphenylmethane, 1,2-bis[(2-methylphenyl)amino]ethane, 1,2-bis(phenylamino)propane, (o-tolyl)biguanide, bis[4-(1′,3′-dimethylbutyl)phenyl]amine, tert-octylated N-phenyl-1-naphthylamine, mixture of mono- and dialkylated tert-butyl/tert-octyldiphenylamines, mixture of mono- and dialkylated nonyidiphenylamines, mixture of mono- and dialkylated dodecyldiphenylamines, mixture of mono- and dialkylated isopropyl/isohexyldiphenylamines, mixture of mono- and dialkylated tert-butyldiphenylamines, 2,3-dihydro-3,3-dimethyl-4H-1,4-benzothiazine, phenothiazine, mixture of mono- and dialkylated tert-butyl/tert-octylphenothiazines, mixture of mono- and dialkylated tert-octylphenothiazines, N-allylphenothiazine, N,N,N′,N′-tetraphenyl-1,4-diaminobut-2-ene, N,N-bis(2,2,6,6-tetramethylpiperidin-4-yl)hexamethylenediamine, bis(2,2,6,6-tetramethylpiperidin-4-yl) sebacate, 2,2,6,6-tetramethylpiperidin-4-one, 2,2,6,6-tetramethylpiperidin-4-ol, the dimethyl succinate polymer with 4-hydroxy-2,2,6,6-tetramethyl-1-piperidinethanol [CAS number 65447-77-0] (for example Tinuvin® 622 from Ciba Specialty Chemicals, Switzerland) and the polymer of 2,2,4,4-tetramethyl-7-oxa-3,20-diazadispiro[5.1.11.2]henicosan-21-one and epichlorhydrin [CAS-No.: 202483-55-4] (for example Hostavin®30 from Ciba Specialty Chemicals, Switzerland).

The group i) of the sterically hindered amines includes, for example, 4-hydroxy-2,2,6,6-tetramethylpiperidine, 1-allyl-4-hydroxy-2,2,6,6-tetramethylpiperidine, 1-benzyl-4-hydroxy-2,2,6,6-tetramethylpiperidine, bis(2,2,6,6-tetramethyl-4-piperidyl) sebacate, bis(2,2,6,6-tetramethyl-4-piperidyl) succinate, bis(1,2,2,6,6-pentamethyl-4-piperidyl) sebacate, bis(1-octyloxy-2,2,6,6-tetramethyl-4-piperidyl) sebacate, bis(1,2,2,6,6-pentamethyl-4-piperidyl)(n-butyl)(3,5-di(tert-butyl)-4-hydroxybenzyl)malonate ((n-butyl)(3,5-di(tert-butyl)-4-hydroxybenzyl)malonic acid bis(1,2,2,6,6-pentamethylpiperidyl) ester), condensation product of 1-(2-hydroxyethyl)-2,2,6,6-tetramethyl-4-hydroxypiperidine and succinic acid, linear or cyclic condensation products of N,N′-bis(2,2,6,6-tetramethyl-4-piperidyl)hexamethylenediamine and 4-(tert-octylamino)-2,6-dichloro-1,3,5-triazine, tris(2,2,6,6-tetramethyl-4-piperidyl) nitrilotriacetate, tetrakis(2,2,6,6-tetramethyl-4-piperidyl) 1,2,3,4-butanetetracarboxylate, 1,1′-(1,2-ethanediyl)bis(3,3,5,5-tetramethylpiperazinone), 4-benzoyl-2,2,6,6-tetramethylpiperidine, 4-stearyloxy-2,2,6,6-tetramethylpiperidine, bis(1,2,2,6,6-pentamethylpiperidyl) 2-(n-butyl)-2-(2-hydroxy-3,5-di(tert-butyl)benzyl)malonate, 3-(n-octyl)-7,7,9,9-tetramethyl-1,3,8-triazaspiro[4.5]decane-2,4-dione, bis(1-octyloxy-2,2,6,6-tetramethylpiperidyl) sebacate, bis(1-octyloxy-2,2,6,6-tetramethylpiperidyl) succinate, linear or cyclic condensation products of N,N′-bis(2,2,6,6-tetramethyl-4-piperidyl)hexamethylenediamine and 4-morpholino-2,6-dichloro-1,3,5-triazine, condensation product of N,N′-bis(2,2,6,6-tetramethyl-4-piperidyl)hexamethylene-diamine and formic acid ester (CAS No.124172-53-8, e.g. Uvinul® 4050H from BASF AG, Ludwigshafen), condensation product of 2-chloro-4,6-bis(4-(n-butyl)amino-2,2,6,6-tetramethylpiperidyl)-1,3,5-triazine and 1,2-bis(3-aminopropylamino)ethane, condensation product of 2-chloro-4,6-di(4-(n-butyl)amino-1,2,2,6,6-pentamethyl-piperidyl)-1,3,5-triazine and 1,2-bis(3-aminopropylamino)ethane, 8-acetyl-3-dodecyl-7,7,9,9-tetramethyl-1,3,8-triazaspiro[4.5]decane-2,4-dione, 3-dodecyl-1-(2,2,6,6-tetramethyl-4-piperidyl)pyrrolidine-2,5-dione, 3-dodecyl-1-(1,2,2,6,6-pentamethyl-4-piperidyl)pyrrolidine-2,5-dione, mixture of 4-hexadecyloxy- and 4-stearyloxy-2,2,6,6-tetramethylpiperidine, condensation product of N,N′-bis(2,2,6,6-tetramethyl-4-piperidyl)hexamethylenediamine and 4-cyclohexylamino-2,6-dichloro-1,3,5-triazine, condensation product of 1,2-bis(3-aminopropylamino)ethane and 2,4,6-trichloro-1,3,5-triazine, as well as 4-butylamino-2,2,6,6-tetramethylpiperidine (CAS Reg. No. [136504-96-6]); N-(2,2,6,6-tetramethyl-4-piperidyl)-(n-dodecyl)succinimide, N-(1,2,2,6,6-pentamethyl-4-piperidyl)-(n-dodecyl)succinimide, 2-undecyl-7,7,9,9-tetramethyl-1-oxa-3,8-diaza-4-oxospiro[4.5]decane, reaction product of 7,7,9,9-tetramethyl-2-cycloundecyl-1-oxa-3,8-diaza-4-oxospiro[4.5]decane and epichlorohydrin, 1,1-bis(1,2,2,6,6-pentamethyl-4-piperidyloxycarbonyl)-2-(4-methoxyphenyl)ethene, N,N′-bisformyl-N,N′-bis(2,2,6,6-tetramethyl-4-piperidyl)hexamethylenediamine, diester of 4-methoxymethylenemalonic acid with 1,2,2,6,6-pentamethyl-4-hydroxypiperidine, poly[methylpropyl-3-oxo-4-(2,2,6,6-tetramethyl-4-piperidyl)]siloxane, reaction product of maleic anhydride/α-olefin copolymer and 2,2,6,6-tetramethyl-4-aminopiperidine or 1,2,2,6,6-pentamethyl-4-aminopiperidine, copolymers of (partially) N-(piperidin-4-yl)-substituted maleimide and a mixture of α-olefins, such as, e.g. Uvinul® 5050H (BASF AG, Ludwigshafen), 1-(2-hydroxy-2-methylpropoxy)-4-octadecanoyloxy-2,2,6,6-tetramethylpiperidine,1-(2-hydroxy-2-methylpropoxy)-4-hexadecanoyloxy-2,2,6,6-tetramethylpiperidine, the reaction product of 1-oxy-4-hydroxy-2,2,6,6-tetramethylpiperidine and a carbon radical of t-amyl alcohol, 1-(2-hydroxy-2-methylpropoxy)-4-hydroxy-2,2,6,6-tetramethylpiperidine, 1-(2-hydroxy-2-methylpropoxy)-4-oxo-2,2,6,6-tetramethylpiperidine, bis(1-(2-hydroxy-2-methylpropoxy)-2,2,6,6-tetramethylpiperidin-4-yl) sebacate, bis(1-(2-hydroxy-2-methylpropoxy)-2,2,6,6-tetramethylpiperidin-4-yl) adipate, bis(1-(2-hydroxy-2-methylpropoxy)-2,2,6,6-tetramethylpiperidin-4-yl) succinate, bis(1-(2-hydroxy-2-methylpropoxy)-2,2,6,6-tetramethylpiperidin-4-yl) glutarate, 2,4-bis{N-[1-(2-hydroxy-2-methylpropoxy)-2,2,6,6-tetramethylpiperidin-4-yl]-N-butylamino}-6-(2-hydroxyethylamino)-s-triazine, N,N′-bisformyl-N,N′-bis(1,2,2,6,6-pentamethyl-4-piperidyl)hexamethylenediamine, hexahydro-2,6-bis(2,2,6,6-tetramethyl-4-piperidyl)-1H,4H,5H,8H-2,3a,4a,6,7a,8a-hexaazacyclopenta[def]fluorene-4,8-dione (e.g. Uvinul® 4049 from BASF AG, Ludwigshafen), poly[[6-[(1,1,3,3-tetramethylbutyl)amino]-1,3,5-triazine-2,4-diyl][(2,2,6,6-tetramethyl-4-piperidinyl)imino]-1,6-hexanediyl[(2,2,6,6-tetramethyl-4-piperidinyl)imino]] [CAS No. 71878-19-8] or N,N′,N′,N′-tetrakis (4,6-bis(butyl(N-methyl-2,2,6,6-tetramethylpiperidin -4-yl)amino)triazin-2-yl)-4,7-diazadecane-1,10-diamine (CAS No.106990-43-6) (e.g. Chimassorb® 119 from Ciba Specialty Chemicals, Switzerland).

The group j) of the metal deactivators includes, for example, N,N′-diphenyloxamide, N-salicylal-N′-salicyloylhydrazine, N,N′-bis(salicyloyl)hydrazine, N,N′-bis(3,5-di(tert-butyl)-4-hydroxyphenylpropionyl)hydrazine, 3-salicyloylamino-1,2,4-triazole, bis(benzylidene)oxalic acid dihydrazide, oxanilide, isophthalic acid dihydrazide, sebacic acid bisphenylhydrazide, N,N′-diacetyladipodihydrazide, N,N′-bis(salicyloyl)oxalodihydrazide or N,N′-bis(salicyloyl)thiopropionodihydrazide.

The group k) of the phosphites and phosphonites includes, for example, triphenyl phosphite, diphenyl alkyl phosphites, phenyl dialkyl phosphites, tris(nonylphenyl) phosphite, trilauryl phosphite, trioctadecyl phosphite, distearyl pentaerythritol diphosphite, tris(2,4-di(tert-butyl)phenyl) phosphite, diisodecyl pentaerythritol diphosphite, bis(2,4-di(tert-butyl)phenyl) pentaerythritol diphosphite, bis(2,6-di(tert-butyl)-4-methylphenyl) pentaerythritol diphosphite, diisodecyloxy pentaerythritol diphosphite, bis(2,4-di(tert-butyl)-6-methylphenyl) pentaerythritol diphosphite, bis(2,4,6-tris(tert-butyl)phenyl) pentaerythritol diphosphite, tristearyl sorbitol triphosphite, tetrakis(2,4-di(tert-butyl)phenyl) 4,4′-biphenylenediphosphonite, 6-isooctyloxy-2,4,8,10-tetra(tert-butyl)dibenzo[d,f][1,3,2]dioxaphosphepin, 6-fluoro-2,4,8,10-tetra(tert-butyl)-12-methyldibenzo[d,g][1,3,2]dioxaphosphocin, bis(2,4-di(tert-butyl)-6-methylphenyl) methyl phosphite, bis(2,4-di(tert-butyl)-6-methylphenyl) ethyl phosphite, 2,2′,2″-nitrilo[triethyl tris(3,3′,5,5′-tetra(tert-butyl)-1,1′-biphenyl-2,2′-diyl) phosphite] and 2-ethylhexyl (3,3′,5,5′-tetra(tert-butyl)-1,1′-biphenyl-2,2′-diyl) phosphite.

The group l) of the hydroxylamines includes, for example, N,N-dibenzylhydroxylamine, N,N-diethylhydroxylamine, N,N-dioctylhydroxylamine, N,N-dilaurylhydroxylamine, N,N-ditetradecylhydroxylamine, N,N-dihexadecylhydroxylamine, N,N-dioctadecyl-hydroxylamine, N-hexadecyl-N-octadecylhydroxylamine, N-heptadecyl-N-octa-decylhydroxylamine, N-methyl-N-octadecylhydroxylamine and N,N-dialkylhydroxylamine from hydrogenated tallow fatty amines.

The group m) of the nitrones includes, for example, N-benzyl-α-phenylnitrone, N-ethyl-α-methylnitrone, N-octyl-α-heptylnitrone, N-lauryl-α-undecylnitrone, N-tetradecyl-α-tridecylnitrone, N-hexadecyl-α-pentadecylnitrone, N-octadecyl-α-heptadecylnitrone, N-hexadecyl-α-heptadecyinitrone, N-octadecyl-α-pentadecylnitrone, N-heptadecyl-α-heptadecylnitrone, N-octadecyl-α-hexadecylnitrone, N-methyl-α-heptadecyinitrone and nitrones derived from N,N-dialkylhydroxylamines prepared from hydrogenated tallow fatty amines.

The group n) of the amine oxides includes, for example, amine oxide derivatives as disclosed in U.S. Pat. Nos. 5,844,029 and 5,880,191, didecylmethylamine oxide, tridecylamine oxide, tridodecylamine oxide and trihexadecylamine oxide.

The group o) of the benzofuranones and indolinones includes, for example, those disclosed in U.S. Pat. Nos. 4,325,863, 4,338,244, 5,175,312, 5,216,052 or 5,252,643, in DE-A-4316611, in DE-A-4316622, in DE-A-4316876, in EP-A-0589839 or in EP-A-0591102 or 3-[4-(2-acetoxyethoxy)phenyl]-5,7-di(tert-butyl)benzofuran-2-one, 5,7-di(tert-butyl)-3-[4-(2-stearoyloxyethoxy)phenyl]benzofuran-2-one, 3,3′-bis[5,7-di(tert-butyl)-3-(4-[2-hydroxyethoxy]phenyl)benzofuran-2-one], 5,7-di(tert-butyl)-3-(4-ethoxyphenyl)benzofuran-2-one, 3-(4-acetoxy-3,5-dimethylphenyl)-5,7-di(tert-butyl)benzofuran-2-one, 3-(3,5-dimethyl-4-pivaloyloxyphenyl)-5,7-di(tert-butyl)benzofuran-2-one, 3-(3,4-dimethylphenyl)-5,7-di(tert-butyl)benzofuran-2-one, Irganoxs HP-136 from Ciba Specialty Chemicals, Switzerland and 3-(2,3-dimethylphenyl)-5,7-di(tert-butyl)benzofuran-2-one.

The group p) of the thiosynergists includes, for example, dilauryl thiodipropionate or distearyl thiodipropionate.

The group q) of the peroxide-destroying compounds includes, for example, esters of β-thiodipropionic acid, for example the lauryl, stearyl, myristyl or tridecyl ester, mercaptobenzimidazole or the zinc salt of 2-mercaptobenzimidazole, zinc dibutyldithiocarbamate, dioctadecyl disulfide or pentaerythritol tetrakis(β-dodecylmercaptopropionate).

The compositions used in step a) can also comprise, as effect substances, one or more active substances suitable for protecting wood or comparable lignocellulose materials from attack or destruction by harmful organisms.

Examples of such harmful organisms are:
wood-discoloring fungi, e.g. Ascomycetes, such as Ophiostoma sp. (e.g. Ophiostoma piceae, Ophiostoma piliferum), Ceratocystis sp. (e.g. Ceratocystis coerulescens), Aureobasidium pullulans, Sclerophoma sp. (e.g. Sclerophoma pityophila); Deuteromycetes, such as Aspergillus sp. (e.g. Aspergillus niger), Cladosporium sp. (e.g. Cladosporium sphaerospermum), Penicillium sp. (e.g. Penicillium funiculosum), Trichoderma sp. (e.g. Trichoderma viride), Alternaria sp. (e.g. Alternaria alternata), Paecilomyces sp. (e.g. Paecilomyces variotii); Zygomycetes, such as Mucor sp. (e.g. Mucor hiemalis);
wood-destroying fungi: Ascomycetes, such as Chaetomium sp. (e.g. Chaetomium globosum), Humicola sp. (e.g. Humicola grisea), Petriella sp. (e.g. Petriella setifera), Trichurus sp. (e.g. Trichurus spiralis); Basidiomycetes, such as Coniophora sp. (e.g. Coniophora puteana), Coriolus sp. (e.g. Coriolus versicolor), Gloeophyllum sp. (e.g. Gloeophyllum trabeum), Lentinus sp. (e.g. Lentinus lepideus), Pleurotus sp. (e.g. Pleurotus ostreatus), Poria sp. (e.g. Poria placenta, Poria vaillantii), Serpula sp. (e.g. Serpula lacrymans) and Tyromyces sp. (e.g. Tyromyces palustris), and
wood-destroying insects, e.g. Cerambycidae, such as Hylotrupes bajulus, Callidium violaceum; Lyctidae, such as Lyctus linearis, Lyctus brunneus; Bostrichidae, such as Dinoderus minutus; Anobiidae, such as Anobium punctatum, Xestobium rufovillosum; Lymexylidae, such as Lymexylon navale; Platypodidae, such as Platypus cylindrus; Oedemeridae, such as Nacerda melanura; Formicidae, such as Camponotus abdominalis, Lasius flavus, Lasius brunneus, Lasius fuliginosus.

Fungicidal active substances, insecticidal active substances and bactericides are accordingly suitable, in particular:

Fungicides from the following groups:
dicarboximides, such as iprodione, myclozolin, procymidone or vinclozolin;
acylalanines, such as benalaxyl, metalaxyl, ofurace or oxadixyl;
amine derivatives, such as aldimorph, dodine, dodemorph, fenpropimorph, fenpropidin, guazatine, iminoctadine, spiroxamine or tridemorph;
anilinopyrimidines, such as pyrimethanil, mepanipyrim or cyprodinil;
antibiotics, such as cycloheximide, griseofulvin, kasugamycin, natamycin, polyoxin or streptomycin;
azoles (conazoles), such as azaconazole, bitertanol, bromoconazole, cyproconazole, diclobutrazole, difenoconazole, diniconazole, epoxiconazole, fenbuconazole, fluquinconazole, flusilazole, flutriafol, ketoconazole, hexaconazole, imazalil, metconazole, myclobutanil, penconazole, propiconazole, prochloraz, prothioconazole, tebuconazole, tetraconazole, triadimefon, triadimenol, triflumizole or triticonazole;
dithiocarbamates: ferbam, nabam, maneb, mancozeb, metam, metiram, propineb, polycarbamate, thiram, ziram or zineb;
heterocyclic compounds, such as anilazine, benomyl, boscalid, carbendazim, carboxin, oxycarboxin, cyazofamid, dazomet, dithianon, famoxadone, fenamidone, fenarimol, fuberidazole, flutolanil, furametpyr, isoprothiolane, mepronil, nuarimol, probenazole, proquinazid, pyrifenox, pyroquilon, quinoxyfen, silthiofam, thiabendazole, thifluzamide, thiophanate-methyl, tiadinil, tricyclazole or triforine;
nitrophenyl derivatives, such as binapacryl, dinocap, dinobuton or nitrothal-isopropyl;
phenylpyrroles, such as fenpiclonil and fludioxonil;
2-methoxybenzophenones, such as are disclosed in EP-A 897 904 by the general formula I, e.g. metrafenone;
unclassified fungicides, such as acibenzolar-S-methyl, benthiavalicarb, carpropamid, chlorothalonil, cymoxanil, diclomezine, diclocymet, diethofencarb, edifenphos, ethaboxam, fenhexamid, fentin acetate, fenoxanil, ferimzone, fluazinam, fosetyl, fosetyl-aluminum, iprovalicarb, hexachlorobenzene, metrafenone, pencycuron, propamocarb, phthalide, tolclofos-methyl, quintozene or zoxamide;
strobilurins, such as are disclosed in WO 03/075663 by the general formula I, e.g.: azoxystrobin, dimoxystrobin, fluoxastrobin, kresoxim-methyl, metominostrobin, orysastrobin, picoxystrobin, pyraclostrobin and trifloxystrobin;
sulfenic acid derivatives, such as captafol, captan, dichlofluanid, folpet or tolylfluanid;
cinnamamides and analogous compounds, such as dimethomorph, flumetover or flumorph;
6-aryl-[1,2,4]triazolo[1,5-a]pyrimidines, such as are disclosed, e.g., in WO 98/46608, WO 99/41255 or WO 03/004465, in each case by the general formula I;
amide fungicides, such as cyflufenamid and (Z)-N-[α-(cyclopropylmethoxyimino)-2,3-difluoro-6-(difluoromethoxy)benzyl]-2-phenylacetamide;
iodo compounds, such as diiodomethyl p-tolyl sulfone, 3-iodo-2-propynyl alcohol, (4-chlorophenyl)(3-iodopropargyl)formaldehyde, 3-bromo-2,3-diiodo-2-propenyl ethyl carbonate, 2,3,3-triiodoallyl alcohol, 3-bromo-2,3-diiodo-2-propenyl alcohol, 3-iodo-2-propynyl (n-butyl)carbamate, 3-iodo-2-propynyl (n-hexyl)carbamate, 3-iodo-2-propynyl phenylcarbamate, O-1-(6-iodo-3-oxohex-5-ynyl) butylcarbamate, O-1-(6-iodo-3-oxohex-5-ynyl) phenylcarbamate or napcocide;
phenol derivatives, such as tribromophenol, tetrachlorophenol, 3-methyl-4-chlorophenol, dichlorophen, o-phenylphenol, m-phenylphenol or 2-benzyl-4-chlorophenol;
isothiazolinones, such as N-methylisothiazolin-3-one, 5-chloro-N-methylisothiazolin-3-one, 4,5-dichloro-N-octylisothiazolin-3-one or N-octylisothiazolin-3-one;
(benz)isothiazolinones, such as 1,2-benzisothiazol-3(2H)-one, 4,5-dimethylisothiazol-3-one or 2-octyl-2H-isothiazol-3-one;
pyridines, such as 1-hydroxy-2-pyridinethione (and their Na, Fe, Mn or Zn salts), or tetrachloro-4-(methylsulfonyl)pyridine;
metal soaps, such as tin, copper or zinc naphthenate, octate, 2-ethylhexanoate, oleate, phosphate or benzoate;
organotin compounds, e.g. tributyltin (TBT) compounds, such as tributyltin and tributyl(mononaphthenoyloxy)tin derivatives;
dialkyldithiocarbamate and the Na and Zn salts of dialkyldithiocarbamates, or tetramethylthiuram disulfide;
nitriles, such as 2,4,5,6-tetrachloroisophthalodinitrile;
benzothiazoles, such as 2-mercaptobenzothiazole;
quinolines, such as 8-hydroxyquinoline, and their Cu salts;
tris(N-cyclohexyldiazeniumdioxy)aluminum, (N-cyclohexyldiazeniumdioxy)tributyltin or bis(N-cyclohexyldiazeniumdioxy)copper;
3-(benzo(b)thien-2-yl)-5,6-dihydro-1,4,2-oxathiazin 4-oxide (bethoxazin).

Insecticides from the following groups:
organophosphates, such as azinphos-methyl, azinphos-ethyl, chlorpyrifos, chlorpyrifos-methyl, chlorfenvinphos, diazinon, dimethylvinphos, dioxabenzofos, disulfoton, ethion, EPN, fenitrothion, fenthion, heptenophos, isoxathion, malathion, methidathion, methyl parathion, paraoxon, parathion, phenthoate, phosalone, phosmet, phorate, phoxim, pirimiphos-methyl, profenofos, prothiofos, pirimiphos-ethyl, pyraclofos, pyridaphenthion, suiprofos, triazophos, trichlorfon, tetrachlorvinphos or vamidothion;
carbamates, such as alanycarb, benfuracarb, bendiocarb, carbaryl, carbofuran, carbosulfan, fenoxycarb, furathiocarb, indoxacarb, methiocarb, pirimicarb, propoxur, thiodicarb or triazamate;
pyrethroids, such as bifenthrin, cyfluthrin, cycloprothrin, cypermethrin, deltamethrin, esfenvalerate, etofenprox, fenpropathrin, fenvalerate, cyhalothrin, lambda-cyhalothrin, permethrin, silafluofen, tau-fluvalinate, tefluthrin, tralomethrin or alpha-cypermethrin;
arthropodal growth regulators: a) chitin synthesis inhibitors, e.g. benzoylureas, such as chlorfluazuron, diflubenzuron, flucycloxuron, flufenoxuron, hexaflumuron, lufenuron, novaluron, teflubenzuron, triflumuron, buprofezin, diofenolan, hexythiazox, etoxazole or clofentezine; b) ecdysone antagonists, such as halofenozide, methoxyfenozide or tebufenozide; c) juvenile hormone mimics, such as pyriproxyfen or methoprene; d) lipid biosynthesis inhibitors, such as spirodiclofen;
neonicotinoids, such as flonicamid, clothianidin, dinotefuran, imidacloprid, thiamethoxam, nithiazine, acetamiprid or thiacloprid;
additional unclassified insecticides, such as abamectin, acequinocyl, amitraz, azadirachtin, bifenazate, cartap, chlorfenapyr, chlordimeform, cyromazine, diafenthiuron, diofenolan, emamectin, endosulfan, fenazaquin, formetanate, formetanate hydrochloride, hydramethylnon, indoxacarb, piperonyl butoxide, pyridaben, pymetrozine, spinosad, thiamethoxam, thiocyclam, pyridalyl, fluacyprim, milbemectin, spiromesifen, flupyrazofos, NCS 12, flubendiamide, bistrifluron, benclothiaz, pyrafluprole, pyriprole, amidoflumet, flufenerim, cyflumetofen, lepimectin, profluthrin, dimefluthrin and metaflumizone; and

Bactericides: e.g. isothiazolones, such as 1,2-benzisothiazol-3(2H)-one (BIT), mixtures of 5-chloro-2-methyl-4-isothiazolin-3-one with 2-methyl-4-isothiazolin-3-one and also 2-(n-octyl)-4-isothiazolin-3-one (OIT), furthermore carbendazim, chlorotoluron, 2,2-dibromo-3-nitrilopropionamide (DBNPA), fluometuron, 3-iodo-2-propynyl butylcarbamate (IPBC), isoproturon, prometryn or propiconazole.

The concentration of active or effect substance in the composition depends in a way known per se on the purpose desired for the application and typically ranges from 0.01 to 60% by weight, in particular from 0.05 to 20% by weight, based on the total weight of the composition. For colorants, the concentration typically ranges from 0.1 to 20% by weight, based on the weight of the dispersion; for active substances, the concentration typically ranges from 0.05 to 5% by weight; for UV stabilizers, the concentration typically ranges from 0.05 to 5% by weight; and, for antioxidants, the concentration typically ranges from 0.05 to 5% by weight, based on the weight of the composition.

In an additional preferred embodiment of the invention, the aqueous dispersion, in addition to the effect substance, already comprises at least one of those crosslinkable compounds which are present in the composition used in step b). Such compositions are novel and are likewise an object of the present invention. With regard to the preferred components, the concentrations, and the like, of these compositions, the following clarifications for the composition used in step b) are similarly valid.

The impregnation of the lignocellulose material with the effect substance composition in step a) can be carried out in a way conventional per se, e.g. by immersion, by application of vacuum, if appropriate in combination with pressure, or by conventional application methods, such as painting, spraying and the like. The impregnation method used in each case naturally depends on the size of the material to be impregnated. Lignocellulose materials which are small in size, such as chips or strands, and also thin veneers, i.e. materials with a high ratio of surface area to volume, can be impregnated cheaply, e.g. by immersion or spraying, whereas lignocellulose materials which are larger in size, in particular materials having a smallest dimension of more than 5 mm, e.g. solid wood, moldings made of solid wood or woodbase materials, are impregnated by application of pressure or vacuum, in particular by combined application of pressure and vacuum. The impregnation is advantageously carried out at a temperature of less than 50° C., e.g. in the range from 15 to 50° C.

The conditions of the impregnation are generally chosen so that the amount of aqueous composition taken up is at least 20% by weight, frequently at least 30% by weight, based on the dry weight of the untreated material. The amount of aqueous composition taken up can be up to 100% by weight, based on the dry weight of the untreated material, and is frequently in the range from 20 to 100% by weight, preferably in the range from 30 to 100% by weight and in particular in the range from 40 to 100% by weight, based on the dry weight of the untreated material used. The moisture content of the untreated materials used for the impregnation is not critical and can, for example, be up to 100%. Here and subsequently, the term “moisture content” is synonymous with the term “residual moisture content” according to DIN 52183. The residual moisture content is preferably below the fiber saturation point of the wood. It is frequently in the range from 1 to 80%, in particular 5 to 50%.

For immersion, the lignocellulose material, if appropriate after predrying, is immersed in a container comprising the aqueous composition. The immersion is preferably carried out over a period of time from a few seconds to 24 h, in particular 1 min to 6 h. The temperatures usually range from 15° C. to 50° C. Doing this, the lignocellulose material takes up the aqueous composition, it being possible for the amount of effect substances taken up by the lignocellulose material to be controlled by the concentration of effect substances in the aqueous composition, by the temperature and by the duration of treatment. The amount of effect substances actually taken up can be determined and controlled by a person skilled in the art in a simple way via the increase in weight of the impregnated material and the concentration of the effect substances in the aqueous composition. Veneers can, for example, be prepressed using press rolls, i.e. calenders, which are present in the aqueous impregnation composition. The vacuum occurring in the wood on relaxation then results in an accelerated uptake of aqueous impregnation composition.

The impregnation is advantageously carried out by combined application of reduced and increased pressure. For this, the lignocellulose material, which generally exhibits a moisture content in the range from 1% to 100%, is first brought into contact with the aqueous composition, e.g. by immersion in the aqueous composition, under a reduced pressure which is frequently in the range from 10 to 500 mbar and in particular in the range from 40 to 100 mbar. The duration is usually in the range from 1 min to 1 h. This is followed by a phase at increased pressure, e.g. in the range from 2 to 20 bar, in particular from 4 to 15 bar and especially from 5 to 12 bar. The duration of this phase is usually in the range from 1 min to 12 h. The temperatures are usually in the range from 15 to 50° C. Doing this, the lignocellulose material takes up the aqueous composition, it being possible for the amount of composition and accordingly of effect substances taken up by the lignocellulose material to be controlled by the concentration of the effect substances in the aqueous composition, by the pressure, by the temperature and by the duration of treatment. The amount of effect substances actually taken up can also here be calculated via the increase in weight of the lignocellulose material.

Furthermore, the impregnation can be carried out by conventional methods for applying liquids to surfaces, e.g. by spraying or rolling or painting. With regard to this, use is advantageously made of a material with a moisture content of not more than 50%, in particular not more than 30%, e.g. in the range from 12% to 30%. The application is usually carried out at temperatures in the range from 15 to 50° C. The spraying can be carried out in the usual way in all devices suitable for the spraying of flat or finely divided bodies, e.g. using nozzle arrangements and the like. For painting or rolling, the desired amount of aqueous composition is applied to the flat materials with rolls or brushes.

If appropriate, it is possible, before the impregnation in step b), to dry the lignocellulose material obtained in step a), e.g. to a residual moisture content suitable for the impregnation in step b). However, it is also possible to dispense with a drying step or to carry out step a) and step b) together by using an aqueous composition which, in addition to the effect substance, also comprises the crosslinkable compound.

The crosslinkable compounds of the aqueous compositions used in step b) or the crosslinkable compounds in the compositions of the effect substance are low molecular weight compounds or oligomers with low molecular weights which are present in water generally in the completely dissolved form. The molecular weight of the crosslinkable compound is usually less than 400 daltons. It is assumed that the compounds, because of these properties, can penetrate into the cell walls of the wood and, on curing, improve the mechanical stability of the cell walls and reduce the swelling thereof brought about by water.

Examples of crosslinkable compounds are, without being limited thereto:
1,3-bis(hydroxymethyl)-4,5-dihydroxyimidazolidin-2-one (DMDHEU),
1,3-bis(hydroxymethyl)-4,5-dihydroxyimidazolidinone, which is modified with a C₁-C₆-alkanol, a C₂-C₆-polyol or an oligoalkylene glycol (modified DMDHEU or mDMDHEU),
1,3-bis(hydroxymethyl)urea,
1,3-bis(methoxymethyl)urea,
1-hydroxymethyl-3-methylurea,
1,3-bis(hydroxymethyl)imidazolidin-2-one (dimethylolethyleneurea),
1,3-bis(hydroxymethyl)-1,3-hexahydropyrimidin-2-one (dimethylolpropyleneurea),
1,3-bis(methoxymethyl)-4,5-dihydroxyimidazolidin-2-one (DMeDHEU),
tetra(hydroxymethyl)acetylenediurea,
low molecular weight melamine-formaldehyde resins (MF resins), such as 2-, 3-, 4-, 5-, or 6-times methylolated melamine, e.g. tri(hydroxymethyl)melamine (=2,4,6-tris-(N-(hydroxymethyl)amino)-1,3,5-triazine, and
low molecular weight melamine-formaldehyde resins (MF resins), such as 2-, 3-, 4-, 5-, or 6-times methylolated melamine, e.g. tri(hydroxymethyl)melamine, which are modified with a C₁-C₆-alkanol, a C₂-C₆-polyol or an oligoalkylene glycol (modified MF resin).

The crosslinkable compounds are typically used in the form of an aqueous composition.

Aqueous compositions of compounds V, their precondensates and their reaction products are known per se, for example from WO 2004/033171, WO 2004/033170, K. Fisher et al., “Textile Auxiliaries—Finishing Agents”, Chapter 7.2.2, in Ullmann's Encyclopedia of Industrial Chemistry, 5th ed. on CD-ROM, Wiley-VCH, Weinheim, 1997, and the literature cited therein, U.S. Pat. No. 2 731 364, U.S. Pat. No. 2 930 715, H. Diem et al., “Amino-Resins”, Chapter 7.2.1 and 7.2.2 in Ullmann's Encyclopedia of Industrial Chemistry, 5th ed. on CD-ROM, Wiley-VCH, Weinheim, 1997, and the literature cited therein, Houben-Weyl E20/3, pp. 1811-1890, and are conventionally used as crosslinking agents for textile finishing. Reaction products of N-methylolated urea compounds V with alcohols, e.g. modified 1,3-bis(hydroxymethyl)-4,5-dihydroxyimidazolidin-2-one (mDMDHEU), are known, for example from U.S. Pat. No. 4 396 391 and WO 98/29393. Otherwise, compounds V and their reaction products and precondensates are commercially available.

In a preferred embodiment of the invention, the crosslinkable compound is chosen from urea compounds V carrying a CH₂OR group as defined above each time on the nitrogen atoms of the urea unit (N—C(O)—N) and also the reaction products of such urea compounds V with C₁-C₆-alkanols, C₂-C₆-polyols and oligoalkylene glycols. The crosslinkable compound is chosen in particular from 1,3-bis(hydroxymethyl)-4,5-dihydroxyimidazolidin-2-one and a 1,3-bis(hydroxymethyl)-4,5-dihydroxyimidazolidin-2-one modified with a C₁-C₆-alkanol, a C₂-C₆-polyol and/or a polyalkylene glycol. Examples of polyalkylene glycols are in particular the oligo- and poly-C₂-C₄-alkylene glycols mentioned below.

mDMDHEU relates to reaction products of 1,3-bis(hydroxymethyl)-4,5-dihydroxy-imidazolidinon-2-one with a C₁-C₆-alkanol, a C₂-C₆-polyol, an oligoethylene glycol or mixtures of these alcohols. Suitable C₁₋₆-alkanols are, for example, methanol, ethanol, n-propanol, isopropanol, n-butanol and n-pentanol; methanol is preferred. Suitable polyols are ethylene glycol, diethylene glycol, 1,2- and 1,3-propylene glycol, 1,2-, 1,3-, and 1,4-butylene glycol, and glycerol. Examples of suitable polyalkylene glycols are in particular the oligo- and poly-C₂-C₄-alkylene glycols mentioned below. For the preparation of mDMDHEU, DMDHEU is mixed with the alkanol, the polyol or the polyalkylene glycol. In this connection, the monovalent alcohol, the polyol, or the oligo-or polyalkylene glycol are generally used in a ratio of in each case 0.1 to 2.0, in particular 0.2 to 2, molar equivalents, based on DMDHEU. The mixture of DMDHEU, the polyol or the polyalkylene glycol is generally reacted in water at temperatures of preferably 20 to 70° C. and a pH value of preferably 1 to 2.5, the pH value being adjusted after the reaction generally to a range of 4 to 8.

In an additional preferred embodiment of the invention, the crosslinkable compound is chosen from at least 2-times, e.g. 2-, 3-, 4-, 5- or 6-times, in particular a 3-times, methylolated melamine (poly(hydroxymethyl)melamine) and a poly(hydroxy-methyl)melamine modified with a C₁-C₆-alkanol, a C₂-C₆-polyol and/or a polyalkylene glycol. Examples of polyalkylene glycols are in particular the oligo- and poly-C₂-C₄-alkylene glycols mentioned below.

The aqueous compositions to be applied according to the invention can also comprise one or more of the abovementioned alcohols, for example C₁-C₆-alkanols, C₂-C₆-polyols, oligo- and polyalkylene glycols or mixtures of these alcohols. Suitable C₁-6-alkanols are, for example, methanol, ethanol, n-propanol, isopropanol, n-butanol and n-pentanol; methanol is preferred. Suitable polyols are ethylene glycol, diethylene glycol, 1,2- and 1,3-propylene glycol, 1,2-, 1,3-, and 1,4-butylene glycol, and glycerol. Suitable oligo- and polyalkylene glycols are in particular oligo- and poly-C₂-C₄-alkylene glycols, especially homo- and cooligomers of ethylene oxide and/or of propylene oxide, which can be obtained, if appropriate, in the presence of low molecular weight initiators, e.g. aliphatic or cycloaliphatic polyols with at least 2 OH groups, such as 1,3-propanediol, 1,3- and 1,4-butanediol, 1,5-pentanediol, 1,6-hexanediol, glycerol, trimethylolethane, trimethylolpropane, erythritol, and pentaerythritol, as well as pentitols and hexitols, such as ribitol, arabitol, xylitol, dulcitol, mannitol and sorbitol, and also inositol, or aliphatic or cycloaliphatic polyamines with at least 2-NH₂ groups, such as diethylenetriamine, triethylenetetramine, tetraethylenepentamine, 1,3-propylenediamine, dipropylenetriamine, 1,4,8-triazaoctane, 1,5,8,12-tetraazadodecane, hexamethylenediamine, dihexamethylenetriamine, 1,6-bis(3-aminopropylamino)hexane, N-methyidipropylenetriamine or polyethylenimine, preference being given, among these, to diethylene glycol, triethylene glycol, di-, tri- and tetrapropylene glycol and low molecular weight Pluronic® brands from BASF (e.g., Pluronic® PE 3100, PE 4300, PE 4400, RPE 1720, RPE 1740).

The concentration of the crosslinkable compounds in the aqueous composition usually ranges from 1 to 60% by weight, frequently from 10 to 60% by weight and in particular from 15 to 50% by weight, based on the total weight of the composition. If the curable aqueous composition comprises one of the abovementioned alcohols, its concentration preferably ranges from 1 to 50% by weight, in particular from 5 to 40% by weight. The total amount of crosslinkable compound and alcohol usually constitutes 10 to 60% by weight and in particular 20 to 50% by weight of the total weight of the aqueous composition.

The aqueous composition used in step b) generally comprises at least one catalyst K which brings about the crosslinking of the compound V or of its reaction product or precondensate. Metal salts from the group of the metal halides, metal sulfates, metal nitrates, metal phosphates and metal tetrafluoroborates; boron trifluoride; ammonium salts from the group of the ammonium halides, ammonium sulfate, ammonium oxalate and diammonium phosphate; and organic carboxylic acids, organic sulfonic acids, boric acid, phosphoric acid, sulfuric acid and hydrochloric acid are generally suitable as catalyst K.

Examples of metal salts suitable as catalysts K are in particular magnesium chloride, magnesium sulfate, zinc chloride, lithium chloride, lithium bromide, aluminum chloride, aluminum sulfate, zinc nitrate and sodium tetrafluoroborate.

Examples of ammonium salts suitable as catalysts K are in particular ammonium chloride, ammonium sulfate, ammonium oxalate and diammonium phosphate.

Water-soluble organic carboxylic acids, such as maleic acid, formic acid, citric acid, tartaric acid and oxalic acid, furthermore benzenesulfonic acids, such as p-toluenesulfonic acid, but also inorganic acids, such as hydrochloric acid, phosphoric acid, sulfuric acid, boric acid and their mixtures, are also suitable in particular as catalysts K.

The catalyst K is preferably chosen from magnesium chloride, zinc chloride, magnesium sulfate, aluminum sulfate and their mixtures, magnesium chloride being particularly preferred.

The catalyst K will usually be added to the aqueous dispersion only shortly before the impregnation in step b). It is generally used in an amount of 1 to 20% by weight, in particular 2 to 10% by weight, based on the total weight of the curable constituents present in the aqueous composition. The concentration of the catalyst, based on the total weight of the aqueous dispersion, generally ranges from 0.1 to 10% by weight and in particular from 0.5 to 5% by weight.

The impregnation in step b) can be carried out in a way conventional per se, e.g. by immersion, by application of vacuum, if appropriate in combination with pressure, or by conventional application methods, such as painting, spraying and the like. The impregnation method used in each case naturally depends on the size of the material to be impregnated. Lignocellulose materials which are small in size, such as chips or strands, and also thin veneers, i.e. materials with a high ratio of surface area to volume, can be impregnated cheaply, e.g. by immersion or spraying, whereas lignocellulose materials which are larger in size, in particular materials having a smallest dimension of more than 5 mm, e.g. solid wood, moldings made of solid wood or woodbase materials, are impregnated by application of pressure or vacuum, in particular by combined application of pressure and vacuum. The impregnation is advantageously carried out at a temperature of less than 50° C., e.g. in the range from 15 to 50° C.

The conditions of the impregnation in step b) are generally chosen so that the amount of curable constituents of the aqueous composition taken up is at least 1% by weight, based on the dry weight of the material obtained in step a). The amount of curable constituents taken up can be up to 100% by weight, based on the dry weight of the materials obtained in step a), and is frequently in the range from 1 to 60% by weight, preferably in the range from 5 to 50% by weight and in particular in the range from 10 to 30% by weight, based on the dry weight of the material obtained in step a). The moisture content of the materials used for the impregnation in step b) is not critical and can, for example, be up to 100%. Here and subsequently, the term “moisture content” is synonymous with the term “residual moisture content” according to DIN 52183. The residual moisture content is preferably below the fiber saturation point of the wood. It is frequently in the range from 1 to 80%, in particular 5 to 50%.

For immersion, the lignocellulose material, if appropriate after predrying, is immersed in a container comprising the aqueous composition. The immersion is preferably carried out over a period of time from a few seconds to 24 h, in particular 1 min to 6 h. The temperatures usually range from 15° C. to 50° C. Doing this, the lignocellulose material takes up the aqueous composition, it being possible for the amount of the non-aqueous constituents (i.e., curable constituents) taken up by the lignocellulose materials to be controlled by the concentration of these constituents in the aqueous composition, by the temperature and by the duration of treatment. The amount of constituents actually taken up can be determined and controlled by a person skilled in the art in a simple way via the increase in weight of the impregnated material and the concentration of the constituents in the aqueous composition. Veneers can, for example, be prepressed using press rolls, i.e. calenders, which are present in the aqueous impregnation composition. The vacuum occurring in the wood on relaxation then results in an accelerated uptake of aqueous impregnation composition.

The impregnation is advantageously carried out by combined application of reduced and increased pressure. For this, the lignocellulose material, which generally exhibits a moisture content in the range from 1% to 100%, is first brought into contact with the aqueous composition, e.g. by immersion in the aqueous composition, under a reduced pressure which is frequently in the range from 10 to 500 mbar and in particular in the range from 40 to 100 mbar. The duration is usually in the range from 1 min to 1 h. This is followed by a phase at increased pressure, e.g. in the range from 2 to 20 bar, in particular from 4 to 15 bar and especially from 5 to 12 bar. The duration of this phase is usually in the range from 1 min to 12 h. The temperatures are usually in the range from 15 to 50° C. Doing this, the lignocellulose material takes up the aqueous composition, it being possible for the amount of the non-aqueous constituents (i.e., curable constituents) taken up by the lignocellulose material to be controlled by the concentration of these constituents in the aqueous composition, by the pressure, by the temperature and by the duration of treatment. The amount actually taken up can also here be calculated via the increase in weight of the lignocellulose material.

Furthermore, the impregnation can be carried out by conventional methods for applying liquids to surfaces, e.g. by spraying or rolling or painting. With regard to this, use is advantageously made of a material with a moisture content of not more than 50%, in particular not more than 30%, e.g. in the range from 12% to 30%. The application is usually carried out at temperatures in the range from 15 to 50° C. The spraying can be carried out in the usual way in all devices suitable for the spraying of flat or finely divided bodies, e.g. using nozzle arrangements and the like. For painting or rolling, the desired amount of aqueous composition is applied to the flat materials with rolls or brushes.

Subsequently, in step c), the crosslinkable constituents of the aqueous composition used in step b) are cured. The curing can be carried out analogously to the methods described in the state of the art, e.g. according to the methods disclosed in WO 2004/033170 and WO 2004/033171.

Curing is typically carried out by treating the material obtained in step b) at temperatures of greater than 80° C., in particular of greater than 90° C., e.g. in the range from 90 to 220° C. and in particular in the range from 100 to 200° C. The time required for the curing typically ranges from 10 min to 72 hours. Rather higher temperatures and shorter times can be used for veneers and finely divided lignocellulose materials. In the curing, not only are the pores in the lignocellulose material filled with the cured impregnation agent but crosslinking occurs between impregnation agent and the lignocellulose material itself.

If appropriate, it is possible, before the curing, to carry out a drying step, subsequently also referred to as predrying step. In this connection, the volatile constituents of the aqueous composition, in particular the water and excess organic solvents which do not react in the curing/crosslinking of the urea compounds, are partially or completely removed. The term “predrying” means that the lignocellulose material is dried to below the fiber saturation point, which, depending on the type of the material, is approximately 30% by weight. This predrying counteracts, for large-scale bodies, in particular for solid wood, the danger of cracking. For small-scale materials or veneers, the predrying can be omitted. For materials with relatively large sizes, the predrying is advantageous, however. If a separate predrying is carried out, this is advantageously carried out at temperatures in the range from 20 to 80° C. Depending on the drying temperature chosen, partial or complete curing/crosslinking of the curable constituents present in the composition can occur. The combined predrying/curing of the impregnated materials is usually carried out by drawing up a temperature profile which can extend from 50° C. to 220° C., in particular from 80 to 200° C.

The curing/drying can be carried out in a conventional fresh air-outgoing air system, e.g. a rotary drier. The predrying is preferably carried out in a way that the moisture content of the finely divided lignocellulose materials after the predrying is not more than 30%, in particular not more than 20%, based on the dry weight. It can be advantageous to take the drying/curing to a moisture content <10% and in particular less than <5%, based on the dry weight. The moisture content can be controlled in a simple way by the pressure chosen in the predrying, the temperature and the duration.

If appropriate, adhering liquid will be removed mechanically before the drying/curing.

For large-scale materials, it has proven worthwhile to fix these on drying/curing, e.g. in heating presses.

The lignocellulose materials impregnated in step b) or cured in step c) can, if ready-made final products are not already concerned, be further processed in a way known per se, in the case of finely divided materials, e.g., to give moldings, such as OSB (oriented structural board) boards, particle boards, wafer boards, OSL (oriented strand lumber) boards and OSL moldings, PSL (parallel strand lumber) boards and PSL moldings, insulating boards and medium-density (MDF) and high-density (HDF) fiber boards, wood-plastic composites (WPC) and the like, in the case of veneers, to give veneer lumber, such as veneered fiber boards, veneered CLV boards, veneered particle boards, including veneered OSL (oriented strand lumber) and PSL (parallel strand lumber) boards, plywood, glued wood, laminated wood, veneered laminated wood (e.g. Kerto laminated wood), multiplex boards, laminated veneer lumber (LVL), decorative veneer lumber, such as lining, ceiling and prefabricated parquet panels, but also nonplanar, three-dimensionally shaped components, such as laminated wood moldings, plywood moldings and any other molding laminated with at least one layer of veneer. The further processing can be carried out immediately after the impregnation in step b) or during or after the curing in step c). In the case of impregnated veneers, the further processing is advantageously carried out before the curing step or together with the curing step. For moldings made of finely divided materials, the molding step and curing step can be carried out simultaneously.

If the impregnated lignocellulose material is solid wood or a ready-made woodbase material, these can be worked in the usual way before the treatment in step c), e.g. by sawing, planing, grinding, and the like. Impregnated and cured solid wood according to the invention is suitable in particular for the preparation of objects which are subject to humidity and in particular the effects of the weather, e.g. for structural timbers, beams, structural elements made of wood, for wooden balconies, roof shingles, fences, lignocellulose posts, railroad ties or in shipbuilding for the interior finish and superstructure.

The following examples serve to illustrate the invention.

General procedure for the impregnation with pigments:

A commercial solid or aqueous pigment preparation or a liquid dye preparation (see table 1) is diluted with water to the concentration given in table 2. The pH is adjusted to a value of 6-8 by addition of sulfuric acid. 30 parts by weight of a commercial concentrated aqueous preparation of N,N-bis(hydroxymethyl)-4,5-bishydroxyimidazolin-2-one (Fixapret® CP from BASF Aktiengesellschaft) and 1.5 parts by weight of MgCl₂.6H₂O are added, at room temperature with stirring, to 100 parts by weight of this aqueous preparation.

For comparison purposes, corresponding compositions to which no N,N-bis(hydroxymethyl)-4,5-bishydroxyimidazolin-2-one had been added were tested.

A cube of pinewood with the dimensions 3 cm×3 cm×3 cm, sealed on the front face with a 2K varnish, was completely immersed in the preparation thus obtained, loaded with a weight and stored under slight negative pressure for 1 h. The impregnation composition was then allowed to act for a further 4 h at standard pressure. The wood specimens thus impregnated were then dried in a circulating-air drying cabinet at 120° C. for 36 h.

### Performance Test

The test specimens obtained were sawn in half and examined visually for dye penetration. Both the wood specimens prepared according to the invention and the wood specimens not prepared according to the invention were completely penetrated by dye.

For the assessment of the resistance to migration, the halved wood specimens were in each case stored in water for one week at ambient temperature and the bleeding of the colorant was assessed visually. The bleeding was evaluated according to the following scale of grading:
1 no bleeding
2 slight bleeding
3 bleeding
4 strong bleeding

The results are given in table 2.

TABLE 1
Colorants used

| Color- | | | | |
|---|---|---|---|---|
| ant | | | | Content |
| No. | Type | Trade name | C.I. | [%]¹⁾ |
| 1 | Pigment, solid | Xfast Red 2817 | P.R. 101 | 60 |
| 2 | Pigment, solid | Xfast Yellow 1916 | P.Y. 42 | 60 |
| 3 | Pigment, solid | Xfast White ED 7623 | P.W. 6 | 80 |
| 4 | Pigment, solid | Xfast Black 0066 | P.Bl. 72 | 80 |
| 5 | Pigment, solid | Xfast Blue 7080 | P.B. 15:3 | 80 |
| 6 | Pigment, solid | Xfast Blue 6875 | P.B. 15:2 | 80 |
| 7 | Pigment, solid | Xfast Green 8730 | P.G. 7 | 80 |
| 8 | Pigment, solid | Xfast Violet 5894 | P.V. 23 | 80 |
| 9 | Pigment, liquid | Luconyl Red 3855 | P.R. 112 | 40 |
| 10 | Pigment, liquid | Luconyl Blue 7080 | P.B. 15:3 | 50 |
| 11 | Pigment, liquid | Luconyl Green 7830 | P.G. 7 | 50 |
| 12 | Pigment, liquid | Luconyl Yellow 1252 | P.Y. 74 | 50 |
| 13 | Dye, liquid | Fastusol Blue 75 L | — | 40-50 |
| 14 | Dye, liquid | Fastusol Red 43 L | — | 40-50 |
| 15 | Pigment/dye | Xfast Black/Fastusol | — | Ratio |
| | | Blue 75 L | | by weight |
| | | | | 1:2 |

¹⁾Content of colorant, based on commercial product.

All pigment preparations tested comprised polymeric anionic dispersants.

TABLE 2

| | | concentration⁺⁾ | Crosslinking | Resistance to |
|---|---|---|---|---|
| Example No. | Colorant | [% by weight] | agent⁺⁺⁾ | migration |
| 1 | 1 | 7 | yes | 1 |
| 1a | 1 | 7 | no | 3 |
| 2 | 2 | 14 | yes | 1 |
| 2a | 2 | 14 | no | 3 |
| 3 | 3 | 20 | yes | 1 |
| 3a | 3 | 20 | no | 3 |
| 4 | 4 | 5 | yes | 1 |
| 4a | 4 | 5 | no | 3 |
| 5 | 5 | 10 | yes | 1 |
| 5a | 5 | 10 | no | 3 |
| 6 | 6 | 10 | yes | 1 |
| 6a | 6 | 10 | no | 3 |
| 7 | 7 | 10 | yes | 1 |
| 7a | 7 | 10 | no | 3 |
| 8 | 8 | 10 | yes | 1 |
| 8a | 8 | 10 | no | 3 |
| 9 | 9 | 30 | yes | 1 |
| 9a | 9 | 30 | no | 3 |
| 10 | 10 | 20 | yes | 1 |
| 10a | 10 | 20 | no | 3 |
| 11 | 11 | 20 | yes | 1 |
| 11a | 11 | 20 | no | 3 |
| 12 | 12 | 40 | yes | 1 |
| 12a | 12 | 40 | no | 3 |
| 13 | 13 | 10 | yes | 2 |
| 13a* | 13 | 10 | no | 4 |
| 14 | 14 | 10 | yes | 2 |
| 14a* | 14 | 10 | no | 4 |
| 15 | 15 | 15 | yes | 2 |
| 15a* | 15 | 15 | no | 4 |

*not according to the invention
⁺⁾amount of commercial product used according to the general procedure
⁺⁺⁾N,N-bis(hydroxymethyl)-4,5-bishydroxyimidazolin-2-one

1-24. (canceled)

25. A process for the impregnation of lignocellulose materials with effect substances comprising the following steps:
a) impregnating the lignocellulose material with a liquid preparation comprising at least one effect substance in dissolved or dispersed form, wherein the effect substance is chosen from colorants, UV stabilizers and antioxidants, and
b) during or subsequent to step a), impregnating with a curable aqueous composition comprising at least one crosslinkable compound chosen from
α) low molecular weight compounds V exhibiting at least two N-bonded groups of the formula CH₂OR, in which R is hydrogen or C₁-C₄-alkyl, and/or a 1,2-bishydroxyethane-1,2-diyl group bridging two nitrogen atoms,
β) precondensates of the compound V and
γ) reaction products or mixtures of the compound V with at least one alcohol chosen from C₁-C₆-alkanols, C₂-C₆-polyols and oligoalkylene glycols and
c) treating at elevated temperature the material obtained in step b).

26. The process according to claim 25, wherein the effect substance is used in the form of an aqueous composition in which the effect substance is present in dissolved or dispersed form with particle sizes of not more than 2000 nm.

27. The process according to claim 26, wherein the composition used in step a) comprises at least one pigment dispersed in the aqueous phase and/or one dispersed effect substance, other than pigments, having a mean particle size in the range from 50 to 2000 nm.

28. The process according to claim 27, wherein the composition used in step a) comprises at least one polymeric dispersant chosen from anionic and neutral polymeric dispersants.

29. The process according to claim 25, wherein the composition used in step a) comprises an effect substance in a concentration of 0.01 to 60% by weight.

30. The process according to claim 25, wherein the crosslinkable compound of the curable composition is chosen from
1,3-bis(hydroxymethyl)-4,5-dihydroxyimidazolidin-2-one,
1,3-bis(hydroxymethyl)-4,5-dihydroxyimidazolidinone, which is modified with a C₁-C₆-alkanol, a C₂-C₆-polyol or an oligoalkylene glycol,
1,3-bis(hydroxymethyl)urea,
1,3-bis(methoxymethyl)urea,
1-hydroxymethyl-3-methylurea,
1,3-bis(hydroxymethyl)imidazolidin-2-one (dimethylolethyleneurea),
1,3-bis(hydroxymethyl)-1,3-hexahydropyrimidin-2-one (dimethylolpropyleneurea),
1,3-bis(methoxymethyl)-4,5-dihydroxyimidazolidin-2-one (DMeDHEU),
tetra(hydroxymethyl)acetylenediurea,
low molecular weight melamine-formaldehyde resins, and
low molecular weight melamine-formaldehyde resins which are modified with a C₁-C₆-alkanol, a C₂-C₆-polyol or an oligoalkylene glycol (modified MF resin).

31. The process according to claim 25, wherein the concentration of crosslinkable compound in the aqueous curable composition ranges from 1 to 60% by weight, based on the total weight of the composition.

32. The process according to claim 25, wherein the aqueous composition additionally comprises a catalyst K which brings about the curing of the crosslinkable compound.

33. The process according to claim 32, wherein the catalyst K is chosen from metal salts from the group of the metal halides, metal sulfates, metal nitrates, metal phosphates and metal tetrafluoroborates; boron trifluoride; ammonium salts from the group of the ammonium halides, ammonium sulfate, ammonium oxalate and diammonium phosphate; organic carboxylic acids, organic sulfonic acids, boric acid, phosphoric acid, sulfuric acid and hydrochloric acid.

34. The process according to claim 25, wherein step b) is carried out subsequent to step a).

35. The process according to claim 25, wherein steps a) and b) are carried out simultaneously.

36. The process according to claim 35, wherein use is made of an aqueous composition comprising
i) at least one dissolved or dispersed effect substance and
ii) at least one crosslinkable compound chosen from
α) low molecular weight compound V exhibiting at least two N-bonded groups of the formula CH₂OR, in which R is hydrogen or C₁-C₄-alkyl, and/or a 1,2-bishydroxyethane-1,2-diyl group bridging two nitrogen atoms,
β) precondensates of the compounds V and
γ) reaction products or mixtures of the compound V with at least one alcohol chosen from C₁-C₆-alkanols, C₂-C₆-polyols and oligoalkylene glycols.

37. The process according to claim 25, wherein the impregnation is carried out at a temperature of less than 50° C.

38. The process according to claim 25, wherein the lignocellulose material is wood or a woodbase material.

39. A lignocellulose material, which can be obtained by a process according to claim 25.

40. An aqueous composition, comprising
i) at least one dissolved or dispersed effect substance, chosen from colorants, UV stabilizers and antioxidants, and
ii) at least one crosslinkable compound chosen from
α) low molecular weight compounds V exhibiting at least two N-bonded groups of the formula CH₂OR, in which R is hydrogen or C₁-C₄-alkyl, and/or a 1,2-bishydroxyethane-1,2-diyl group bridging two nitrogen atoms,
β) precondensates of the compound V and
γ) reaction products or mixtures of the compound V with at least one alcohol chosen from C₁-C₆-alkanols, C₂-C₆-polyols and oligo-C₂-C₄-alkylene glycols.

41. The composition according to claim 40, comprising at least one pigment dispersed in the aqueous phase and/or one dispersed effect substance having a mean particle size in the range from 50 to 2000 nm.

42. The composition according to claim 41, additionally comprising at least one anionic polymeric dispersant.

43. The composition according to claim 40, comprising the effect substance in a concentration of 0.1 to 20% by weight.

44. A lignocellulose article comprising a lignocellulose material impregnated with an aqueous effect substance composition, comprising at least one pigment dispersed in the aqueous phase having a mean particle size in the range from 50 to 2000 nm and at least one anionic polymeric dispersant and at least one nonionic, water-soluble surface-active substance with a polyether structure.

45. The article according to claim 44, wherein the lignocellulose material comprises wood.

46. The article according to claim 45, wherein the lignocellulose material is a body made of solid wood.
